(19) United States
(12) Patent Application Publication
(10) Pub. No.: US 2014/0281993 A1
(43) Pub. Date: Sep. 18, 2014

(54) PROVIDING ACCESS TO CONTENT IN ACCORDANCE WITH A SELECTED LEVEL OF ACCESS FROM A PLURALITY OF GRADUATED LEVELS OF ACCESS

(71) Applicant: Elwha LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(73) Assignee: Elwha LLC, a limited liability company of the State of Delaware

(21) Appl. No.: 13/854,203

(22) Filed: Apr. 1, 2013

Related U.S. Application Data
(63) Continuation of application No. 13/853,706, filed on Mar. 29, 2013.
Application No. 13/853,706 is a continuation-in-part of application No. 13/795,612, filed on Mar. 12, 2013.

(51) Int. Cl. G06F 3/0484

(52) U.S. Cl. CPC G06F 3/0484; G06F 3/04847
USPC 715/719; 715/764; 715/833; 715/835; 715/716

(57) ABSTRACT

Computationally implemented methods and systems include displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees, receiving a selection of the level of access for accessing the content from the plurality of graduated levels of access to the content; and providing access to the content in accordance with the selected level of access. In addition to the foregoing, other aspects are described in the claims, drawings, and text.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

The present application constitutes a continuation-in-part of U.S. patent application Ser. No. 13/795,612, entitled TIERED LATENCY OF ACCESS FOR CONTENT, naming Roderick A. Hyde; Royce A. Levien; Richard T. Lord; Robert W. Lord; Mark A. Malamud; Tony S. Pan; Lowell L. Wood, Jr. as inventors, filed 12, Mar., 2013 with attorney docket no. 0912-003-001-000000, which is currently co-pending or is an application of which a currently co-pending application is entitled to the benefit of the filing date.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.
All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### SUMMARY

In one or more various aspects, a method includes but is not limited to displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees, receiving a selection of the level of access for accessing the content from the plurality of graduated levels of access to the content; and providing access to the content in accordance with the selected level of access. In some implementations, at least one of the registering, detecting, or displaying being performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees, means for receiving a selection of the level of access for accessing the content from the plurality of graduated levels of access to the content, and means for providing access to the content in accordance with the selected level of access. In addition to the foregoing, other system aspects are described in the claims, drawings, and text forming a part of the disclosure set forth herein.

In one or more various aspects, a system includes, but is not limited to, circuitry for displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees, circuitry for receiving a selection of the level of access for accessing the content from the plurality of graduated levels of access to the content, and circuitry for providing access to the content in accordance with the selected level of access. In addition to the foregoing, other system aspects are described in the claims, drawings, and text forming a part of the disclosure set forth herein.

In one or more various aspects, a computer program product, comprising a signal bearing non-transitory storage medium, bearing one or more instructions including, but not limited to, displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees, receiving a selection of the level of access for accessing the content from the plurality of graduated levels of access to the content, and providing access to the content in accordance with the selected level of access. In addition to the foregoing, other computer program product aspects are described in the claims, drawings, and text forming a part of the disclosure set forth herein.

In one or more various aspects, a system includes, but is not limited to a selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees; a selection obtaining module configured to obtain from a content consumer a selection of the level of access for accessing the content from the plurality of graduated levels of access to the content; and a content access providing module configured to provide access to the content following lapse of a latency associated with the selected level of access for accessing the content.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of a computing device operating in a network environment.

FIGS. 2A, 2B, 2C, 2D, 2E, 2F, 2G and 2H show exemplary selection graphical user interfaces (GUIs) that may be displayed by the computing device 10* of FIG. 1.

FIGS. 2J, 2K, and 2M show exemplary visual presentations that may be displayed by the computing device 10* of FIG. 1.

FIG. 3A shows a block diagram of particular implementation of the computing device 10* of FIG. 1.

FIG. 3B shows a block diagram of another implementation of the computing device 10* of FIG. 1

FIG. 4A shows another perspective of the selection GUI presenting module 102* of FIGS. 3A and 3B (e.g., the selection GUI presenting module 102′ of FIG. 3A or the selection GUI presenting module 102″ of FIG. 3B) in accordance with various implementations.

FIG. 4B shows the selection obtaining module 104* of FIGS. 3A and 3B (e.g., the selection obtaining module 104′ of FIG. 3A or the selection obtaining module 104″ of FIG. 3B) in accordance with various implementations.

FIG. 4C shows the content access presenting module 106* of FIGS. 3A and 3B (e.g., the content access presenting module 106′ of FIG. 3A or the content access presenting module 106″ of FIG. 3B) in accordance with various implementations.

FIG. 5 is a high-level logic flowchart of a process, e.g., operational flow 500, according to some embodiments.

FIG. 6A is a high-level logic flowchart of a process depicting alternate implementations of the selection GUI displaying operation 502 of FIG. 5.

FIG. 6B is a high-level logic flowchart of a process depicting alternate implementations of the selection GUI displaying operation 502 of FIG. 5.

FIG. 6C is a high-level logic flowchart of a process depicting alternate implementations of the selection GUI displaying operation 502 of FIG. 5.

FIG. 6D is a high-level logic flowchart of a process depicting alternate implementations of the selection GUI displaying operation 502 of FIG. 5.

FIG. 6E is a high-level logic flowchart of a process depicting alternate implementations of the selection GUI displaying operation 502 of FIG. 5.

FIG. 6F is a high-level logic flowchart of a process depicting alternate implementations of the selection GUI displaying operation 502 of FIG. 5.

FIG. 6G is a high-level logic flowchart of a process depicting alternate implementations of the selection GUI displaying operation 502 of FIG. 5.

FIG. 6H is a high-level logic flowchart of a process depicting alternate implementations of the selection GUI displaying operation 502 of FIG. 5.

FIG. 7 is a high-level logic flowchart of a process depicting alternate implementations of the selection receiving operation 504 of FIG. 5.

FIG. 8A is a high-level logic flowchart of a process depicting alternate implementations of the content access providing operation 506 of FIG. 5.

FIG. 8B is a high-level logic flowchart of a process depicting alternate implementations of the content access providing operation 506 of FIG. 5.

FIG. 8C is a high-level logic flowchart of a process depicting alternate implementations of the content access providing operation 506 of FIG. 5.

FIG. 8D is a high-level logic flowchart of a process depicting alternate implementations of the content access providing operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

In recent years, the rapid development of computing and networking technologies has fueled explosive growth in demand for content. The word “content” for purposes of this description may be in reference to any one or more of a wide variety of data/information that may be made available through today's computing and/or networking technologies. Some examples of content include news (e.g., business or financial news such as stock or commodities prices, celebrity news, agricultural news, sports news, and so forth), information provided through social media, consumable media such as movies, soundtracks, sporting events, and so forth.

As these technologies continue to evolve, consumers of such content (e.g., content consumers or simply “users”) are also demanding earlier and more timely access to content. For example, consumers of content in the financial or commodity industries are demanding increasingly earlier and earlier access to content (e.g., financial or market data such as stock or commodity prices). That is, early knowledge of certain financial/market/commodity information by, for example, institutional content consumers (e.g., banks, brokerage firms, etc.) may provide huge advantages for those institutional content consumers. Similarly, many everyday consumers of consumable media (e.g., movies, sports program, audio recordings, etc.) have a strong desire to access such consumable media as soon as such media becomes available.

It is also recognized that while some content consumers are willing to pay a large premium for accessing content early, other content consumers may not be as willing to pay such a high premium for early access to the same content. It is further recognized that different content consumers will have different needs as to how soon they would like to access content and how much of a premium they would be willing to pay in order to get such content access. Accordingly, computationally-implemented systems and methods are provided herein that allows consumers of content to get earlier access to content by paying higher fees. That is, the computational-implemented systems and methods to be described herein allows a content consumer to select earlier access to content by paying a higher fee, where the earlier the access to content the higher the corresponding or associated fee. In various implementations, the computational-implemented systems and methods may be implemented at a client device (e.g., an end user computer device such as a desktop, a laptop, a mobile device such as a Smartphone or a tablet computer, etc.).

Turning now to FIG. 1, which illustrates an example environment 100 in which the methods, systems, circuitry, and computer program products in accordance with various embodiments may be implemented at a computing device 10*. The computing device 10* may have any one of variety of form factors including, for example, a mobile computing device (e.g., a smartphone, a tablet computer, a laptop, and so forth), a desktop computer, a workstation, a dedicated terminal (e.g., Bloomberg terminal), and so forth. Note that FIGS. 3A and 3B illustrates block diagrams of two alternative implementations of the computing device 10* of FIG. 1. Note further that in the following, “*” represents a wildcard. Thus, references in the following description to, for example, “computing device 10*” may be in reference to the computing device 10* of FIG. 1 as well as the computing device 10′ of FIG. 3A or the computing device 10″ of FIG. 3B.

In various embodiments, the computing device 10* may electronically communicate with one or more content sources 60 and/or one or more content aggregators 50 via one or more wireless and/or wired networks 5. A content source 60 may be any entity that can be the source for content. Examples of a content source 30 content source 60 include, for example, Dow Jones, Nasdaq, Associated Press, Reuters, Bloomberg, New York Times, Twitter (e.g., a celebrity who uses Twitter or other social media such as Facebook, or a layperson providing any information of interest through social media), police or fire department communication channels, HBO, Warner Brothers, Columbia Pictures, NBC Universal, Walt Disney, and so forth.

In contrast, a content aggregator 50 is any entity that can aggregate and relay content to end users (e.g., content consumers). Examples of content aggregator 50 include, for example, Google, Yahoo, MSN, Huffington Post, MarketWatch, and so forth. Examples of the one or more wireless and/or wired networks 5 include for example, at least one of a local area network (LAN), a wireless local area network (WLAN), personal area network (PAN), Worldwide Interoperability for Microwave Access (WiMAX), public switched telephone network (PTSN), general packet radio service (GPRS), cellular networks including cellular data networks, and/or other types of communication networks.

In various embodiments, the computing device 10* may be designed to receive one or more bidding tags 30 from one or more content aggregators 50, from one or more content sources 60, and/or from one or more other network entities. In some cases, a bidding tag 30 may be used in order to elicit bids (e.g., an order or a request for content access) from content consumers. A bidding tag 30 may provide generic information related to a particular content 20 that may be offered for access. In some implementations, the bidding tag 30 may contain just enough information about the particular content 20 to make the particular content 20 identifiable (e.g., identifiable as a particular type of news or a particular movie) to a potential content consumer but without providing or disclosing core component or components of the content 20 (e.g., core component of the content 20 that if revealed would render the content 20 essentially worthless). For example, if the particular content 20 to be offered access to is a movie, then the corresponding bidding tag 30 may include at least the title of the movie, and in some cases, additional data such as names of the cast and/or crew, movie trailer or trailers, and so forth. Further, the corresponding bidding tag 30 would generally not include the entire movie itself.

If the particular content 20 to be offered access to is, on the other hand, financial or market news, then the corresponding bidding tag 30 may merely identify the type of financial/market news (e.g., “Share price of ACME Corp. stocks on May 26, 2016) that is included in the content 20 without providing essential information (e.g., without providing the actual share price) related to the financial/market news. In yet another example, if the particular content 20 to be offered access to is news related to a particular celebrity, than the corresponding bidding tag 30 may indicate that the content 20 is “celebrity news” or may indicate the name of the celebrity without indicating what the news related to the celebrity is all about (e.g., the bidding tag 30 may indicate that the content 20 is news about “Lindsey Lohan” without identifying the specific news related to Lindsey Lohan). Thus, in various implementations, a bidding tag 30 for a particular content 20 to be offered access to may provide certain generic information related to the particular content 20 without providing core or essential data related to the particular content 20.

In response, at least in part, to receiving a bidding tag 30, the computing device 10* may be designed to visually present (e.g., display) a selection graphical user interface (GUI) for selecting a particular level of access for accessing content 20 from a plurality of graduated levels of access for accessing the content 20, the plurality of graduated levels of access for accessing the content 20 being for accessing the content 20 with varying amounts of latencies and for varying amounts of corresponding fees. In other words, the computing device 10* may be designed to present a particular type of GUI (which will be referred to herein as a selection GUI) that allows a user (e.g., content consumer) to select a particular level of access for accessing a particular content, the particular level of access that may be selected being associated with a particular amount of latency for accessing the content and for a particular amount of corresponding fee, the corresponding fee being greater for shorter latencies. Note that examples of selection GUIs that may be displayed by the computing device 10* of FIG. 1 are illustrated in FIGS. 2A, 2B, 2C, 2D, 2E, 2F, 2G, and 2H and which will be discussed in greater detail herein.

In some cases the word “latency” may be in reference to an increment or interval of time between the earliest point in time that a particular content 20 is available for consumption and the point in time that the particular content 20 is actually made available or accessible. For example, in the case where the particular content 20 includes a feature length movie, the related latency may be the amount of time between when the movie is initially released in theaters and the point in time that the movie is made available. In the case where the particular content 20 relates to the price of a particular stock, the related latency may be the amount of time between when the price is first available through Dow Jones or Nasdaq and when the price is actually made accessible or released. In various implementations, the point in time in which the “latency clock” begins may not be relevant since the point in time that the latency clock begins can be completely arbitrary. That is, the phrase “latency” as used herein relates to a time increment or interval. Thus, a more relevant aspect in accordance with these implementations may be the relevant amounts of latencies/fees associated with different levels of content access.

In response to the presentation of a selection GUI by the computing device 10* a content consumer (e.g., an end user) may select a particular level of content access to access content 20 that is associated with a particular level of latency and a particular corresponding fee. In some implementations, in response to receiving the input (e.g., election of a particular level of content access with a particular level of latency/fee) from the content consumer, the computing device 10* may transmit one or more bids 40 (e.g., a request for content 20 for a particular amount of fee/latency) via the one or more wireless and/or wired networks 5. In various embodiments, the one or more bids 40 may be transmitted to one or more content sources 60, to one or more content aggregators 50, and/or to one or more other entities. In response to receiving the one or more bids 40, the one or more content sources 60, the one or more content aggregators 50, and/or the one or more other entities may transmit back to the computing device 10* the content 20 that was requested by the one or more bids 40.

In some implementations, the content 20 that is transmitted to the computing device 10* may be transmitted to the computing device 10* only after the latency that is associated with the agreed upon content access level (e.g., as agreed to through the one or more bids 40) has lapsed. In other implementations, the content 20 may be transmitted to the computing device 10* prior to the agreed upon latency lapsing. In such situations, the computing device 10* may hold the received content 20, at least temporarily, and not release the received content 20 (e.g., not audibly or visually present the received content 20) until the agreed upon latency has lapsed.

In some implementations, the computing device 10* in addition to being able to receive a particular content 20 may also be designed to receive previous viewer information 22 and/or contextual data 24 from the one or more content sources 60, from the one or more content aggregators 50, and/or from the one or more other entities. The previous viewer information 22 that may be acquired by the computing device 10* may provide various information related to users who may have previously viewed a particular content 20. For example, if a particular content consumer elects to receive a specific content 20 (e.g., content 20 that is related to the price of a particular stock on a particular date) one second (e.g., one second latency) following the initial release of the specific content 20, then the computing device 10* may be designed to receive previous viewer information 22 that indicates, for example, how many other content consumers have already previously accessed the content 20, the identities of those other content consumers who have already accessed the content 20, and/or how those other content consumers may have previously viewed the content 20 (e.g., the communication channels such as bandwidth of the communication channels that were used by the other content consumers in order to access the content 20). In some cases, such information may prove valuable to the content consumer (e.g., an institutional user such as a brokerage firm) receiving the content 20 when, for example, the content consumer is making business/financial decisions.

In some implementations, the previous viewer information 22 may be received by the computing device 10* at the same time or proximate to the point in time in which a bidding tag 30 is received by the computing device 10*. By providing such information to a content consumer, the content consumer may make a more informed decision as to whether to purchase the corresponding content 20 for a particular fee with a particular amount of latency. In other implementations, the previous viewer information 22 may be received by the computing device 10* at the same time or proximate to the point in time in which the content 20 is received by the computing device 10*.

As indicated above, in some implementations, the computing device 10* may be designed to receive contextual data 24 in addition to being designed to receive content 20. In various embodiments, contextual data 24 is data that is related to a particular content 20 and that may supplement the related content 20. For example, if the content 20 that is to be received by the computing device 10* is financial/market news (e.g., price of a particular stock or commodity on a particular date) then the computing device 10* may be further designed to receive a corresponding contextual data 24 that provide historical financial/market data (e.g., historical prices of the particular stock or commodity). On the other hand, if the content 20 that is to be received by the computing device 10* is a consumable media such as a feature length movie, then the contextual data 24 that may be received by the computing device 10* may be one or more movie trailers that may be trailers for the movie or for another movie (e.g., another movie in the same genre). A more detailed discussion related to various aspects of the exemplary environment of FIG. 1 will be provided with respect to the processes and operations to be described herein.

Referring now to FIGS. 2A, 2B, 2C, 2D, 2E, 2F, 2G, and 2H, which illustrates exemplary selection GUIs that may be displayed by the computing device 10* of FIG. 1. In various embodiments, the exemplary selection GUIs may be for selecting a level of access for accessing content from a plurality of graduated levels of access for accessing the content, the selected level of access for accessing the content being associated with a particular amount of latency/corresponding fee.

Turning particularly now to FIG. 2A, which illustrated a selection GUI 200a that includes a slider feature 201a for selecting a particular level of access for accessing a particular content 20 from a plurality of graduated levels of access for accessing the content 20 that are each associated with different amounts of latencies/associated fees, where higher fees are associated with lower latencies. The slider feature 201a includes a slider icon 202a that may be designed to be moveable along an elongated element 204a. The slider icon 202a may be moved along the elongated element 204a by a content user (e.g., an end user) by a variety of different means. For example, if the slider feature 201a is being displayed through a touch screen then a content consumer may simply move the slider icon 202a by touching the slider icon 202a with a finger and move the slider icon 202a by simply sliding the content consumer's finger along the elongated element 204a displayed on the touch screen. Alternatively, a curser and a mouse may be used in order to move the slider icon 202a along the elongated element 204a.

The elongated element 204a having a first end 208a and a second end 210a, and the entire length of the elongated element 204a being divided into graduated levels of access for accessing a particular content 20 (e.g., Share price for ACME), the multiple graduated levels of access being represented at multiple points 212a along the elongated element 204a, and each level of access being associated with a different amount of latency and fee. Thus, in order for a content consumer to select a particular level of content access (with a particular amount of latency and fee), the content consumer slides the slider icon 202a until it is located at the desired position (which corresponds to a particular level of content access) along the elongated element 204a and then enters the access level selection by, for example, tapping or clicking the slider icon 202a or icon 205a, or by other means for inputting the selection. As further illustrated in FIG. 2A, the selection GUI 200a may further include a content identifier 206a and an icon 207a for displaying a previous viewer information (e.g., information related to users who have previously accessed the content 20 including number of users who have already accessed the content, the identities of those users, and so forth).

Referring now to FIG. 2B, which shows another exemplary selection GUI 200b that may be presented by the computing device 10* of FIG. 1. As illustrated, the selection GUI 200b includes a plurality of icons 220b that may be clicked or tapped (e.g., tapped on a touch screen) in order to select a level of content access from a plurality of graduated levels of content access. As depicted, each of the illustrated icons may be associated with a different amount of latency (e.g., from zero weeks for the far left icon to 10 weeks to the far right icon). Each of the illustrated icons 220b being associated with a different amount of associated fee (e.g., from $100 for the far left icon to $5 for the far right icon). Thus, each of the icons 220b associated with a different level of content access (e.g., graduated levels of latencies/fees—note that the latencies are inversely related to the fees such that the smaller the latency the higher the associated fee). As further illustrated in FIG. 2B, the selection GUI 200b may further include a content identifier 206b, which identifies the content 20 as being a feature movie with the title “Star Battle.” The selection GUI 200b is further illustrated as having an icon 207b for displaying/retrieving a movie trailer.

Referring to FIG. 2C, which illustrates another exemplary selection GUI 200c that may be presented by the computing device 10* of FIG. 1. The selection GUI 200c, similar to the selection GUI 200a of FIG. 2A, includes a slider feature 201c that further includes a slider icon 202c and an elongated element 204c, the slider icon 202c being moveable along the elongated element 204c based on user input (e.g., user moving the slider icon 202c by sliding a finger along a touch screen or using a cursor to move the slider icon 202c). The different points along the entire length of the elongated element 204c being associated with different levels of access 212c to content 20, where each point along the elongated element 204c being associated with a different amount of latency (e.g., 1 minute, 1 second, 2 microsecond, etc.) and a different amount of fee (e.g., no fee, $10,000, $50,000, etc.). The selection GUI 200c, as further illustrated, includes a content identifier 206c and textual information 209c (which indicates information related to users who had previously accessed the content). In some cases, an end user may use the selection GUI 200c to select a level of content access by moving the slider icon 202c to the appropriate location (e.g., a location that is associated with the desired level of content access for a particular level of latency/fee) along the elongated element 204c and clicking or tapping icon 205c or the slider icon 202c.

FIG. 2D illustrates yet another selection GUI 200d that comprises a slider feature 201d. The slider feature 201d includes a slider icon 202d that is moveable along an elongated element 204d. The illustrated selection GUI 200d may be used by an end user (e.g., content consumer) for selecting an access level for accessing a consumable media, which in this case is a movie. The selection GUI 200d, as depicted, also includes a content identifier 206d and an icon 207d for retrieving/displaying a movie trailer associated with the movie. In some cases, an end user (e.g., content consumer) may use the selection GUI 200d to select a level of content access by moving the slider icon 202d to the appropriate location (e.g., a location that is associated with the desired level of content access for a particular level of latency/fee) along the elongated element 204d and clicking or tapping icon 205d or the slider icon 202d.

FIG. 2E illustrates yet another selection GUI 200e that comprises a slider feature 201e. The slider feature 201e includes a slider icon 202e that is moveable along an elongated element 204e. The illustrated selection GUI 200e may be used by an end user (e.g., content consumer) for selecting an access level for accessing news, which in this case is celebrity news. The selection GUI 200e, as depicted, also includes a content identifier 206e. In some cases, an end user (e.g., content consumer) may use the selection GUI 200e to select a level of content access by moving the slider icon 202e to the appropriate location (e.g., a location that is associated with the desired level of content access for a particular level of latency/fee) along the elongated element 204e and clicking or tapping icon 205e or the slider icon 202e.

FIG. 2F illustrates yet another selection GUI 200f that comprises a slider feature 201f. The slider feature 201f includes a slider icon 202f that is moveable along an elongated element 204f. The illustrated selection GUI 200f may be used by an end user (e.g., content consumer) for selecting an access level for accessing news, which in this case is celebrity news related specifically to Lindsey Lohan. The selection GUI 200f, as depicted, also includes a content identifier 206f, which identifies the content 20 as Lindsey Lohan news, does not identity the type of news (e.g., what type of news related to Lindsey Lohan) that is included in the content 20. In some cases, an end user (e.g., content consumer) may use the selection GUI 200f to select a level of content access by moving the slider icon 202f to the appropriate location (e.g., a location that is associated with the desired level of content access for a particular level of latency/fee) along the elongated element 204f and clicking or tapping icon 205f or the slider icon 202f.

FIG. 2G illustrates yet another selection GUI 200g that comprises a slider feature 201g. The slider feature 201g includes a slider icon 202g that is moveable along an elongated element 204g. Different points along the elongated element 204g being associated with different levels of access 212g to the content 20. The illustrated selection GUI 200g may be used by an end user (e.g., content consumer) for selecting an access level for accessing agricultural news, which in this case is a crop report. The selection GUI 200g, as depicted, also includes a content identifier 206g and previous user information 207g, which indicates information related to users who have previously accessed the content 20. In some cases, an end user (e.g., content consumer) may use the selection GUI 200g to select a level of content access by moving the slider icon 202g to the appropriate location (e.g., a location that is associated with the desired level of content access for a particular level of latency/fee) along the elongated element 204g and clicking or tapping icon 205g or the slider icon 202g.

FIG. 2H illustrates yet another selection GUI 200h that comprises a slider feature 201h. The slider feature 201h includes a slider icon 202h that is moveable along an elongated element 204h. The illustrated selection GUI 200h may be used by an end user (e.g., content consumer) for selecting an access level for accessing Federal Reserve news (e.g., news related interest rates). The selection GUI 200h, as depicted, also includes a content identifier 206h. In some cases, an end user (e.g., content consumer) may use the selection GUI 200h to select a level of content access by moving the slider icon 202h to the appropriate location (e.g., a location that is associated with the desired level of content access for a particular level of latency/fee) along the elongated element 204h and clicking or tapping icon 205h or the slider icon 202h.

Turning now to FIGS. 2J, 2K, and 2M that illustrates various exemplary visual presentations 250* that provides or may be used for accessing content 20. In various embodiments, the example visual presentations 250* illustrated in FIGS. 2J, 2K, and 2M may be displayed by the computing device 10* after a particular amount of latency has lapsed (e.g., the amount of latency, which may be zero in some cases, that was selected using, for example, one of the selection GUI 200* illustrated in FIG. 2A, 2B, 2C, 2D, 2E, 2F, 2G, or 2H. Referring particularly now to FIG. 2J, which shows a visual presentation 250j that displays content 252 in the form of stock market news. The visual presentation 250j also includes previous user information 254 that provides information of one or more users (e.g., content consumers) who have previously accessed the content 20. As further illustrated in FIG. 2J, the visual presentation 250j may also include contextual data 256 in the form of historical market data (e.g., historical stock prices).

FIG. 2K illustrates a visual presentation 250k for accessing content 20, which in this case is a feature length movie (with the title of “The Godmother”). As shown, the visual presentation 250k may include a content identifier 206k and an icon 220k for retrieving and/or playing the movie. In order to retrieve and/or play the movie, the user may tap or click the icon 220k.

FIG. 2M illustrates a visual presentation 250m for access content 20, which in this case is celebrity news. As shown, the visual presentation 250m may include a content identifier 206m and a link 221m (e.g., a hyperlink) for retrieving and/or displaying the celebrity news. In order to retrieve and/or play the movie, the user may tap or click the link 221m.

Referring now to FIGS. 3A and 3B, illustrating two block diagrams representing two different implementations of computing device 10* of FIG. 1 and that can execute the operations and processes to be described herein. In particular, and as will be further described herein, FIG. 3A illustrates a computing device 10′ that is the “hardwired” or “hard” implementation of a system that can implement the operations and processes to be described herein. The computing device 10′ may include certain logic modules including, for example, a selection GUI presenting module 102′, a selection obtaining module 104′, and/or a content access presenting module 106′ that are implemented using purely hardware or circuitry components (e.g., application specific integrated circuit or “ASIC”). In contrast, FIG. 3B illustrates a computing device 10″ that is the “soft” implementation of a system that can implement the operations and processes to be described herein. In various embodiments, the computing device 10″ may include certain logic modules including, for example, a selection GUI presenting module 102″, a selection obtaining module 104″, and/or a content access presenting module 106″ that are implemented using electronic circuitry (e.g., one or more processors including one or more microprocessors, controllers, etc.) executing one or more programming instructions (e.g., software in the form of computer readable instructions 152—see FIG. 3B).

The embodiments of the computing device 10* illustrated in FIGS. 3A and 3B are two extreme implementations of a system in which all of the logic modules (e.g., the selection GUI presenting module 102′, the selection obtaining module 104′, and the content access presenting module 106′) are implemented using purely hardware solutions (e.g., circuitry such as ASIC) as illustrated in FIG. 3A or in which all of the logic modules (e.g., the selection GUI presenting module 102″, the selection obtaining module 104″, and the content access presenting module 106″) are implemented using software solutions (e.g., programmable instructions in the form of computer readable instructions 152 being executed by hardware such as one or more processors) as illustrated in FIG. 3B. Since there are many ways of combining hardware, software, and/or firmware in order to implement the various logic modules (e.g., the selection GUI presenting module 102*, the selection obtaining module 104*, and the content access presenting module 106*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 116 are still needed in order to execute the software. Further details related to the two implementations of the computing device 10* illustrated in FIGS. 3A and 3B will be provided in greater detail below.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring particularly now to FIG. 3A, which illustrates a block diagram of an computing device 10′ that includes a selection GUI presenting module 102′, a selection obtaining module 104′, and/or a content access presenting module 106′, one or more processors 116 (e.g., one or more microprocessors), a memory 114, user interface 110 (e.g., a keyboard, a touchscreen, a microphone, and/or other user input/output devices), and/or a network interface 112 (e.g., a network interface card or “NIC”). In various embodiments, the memory 114 may store one or more applications 160 (e.g., an operating system (OS) 162, one or more browser applications 163, and/or one or more media player applications 164) and content 20. Although not depicted, the memory 114 may further include other types of applications not depicted in FIG. 3A including, for example, communication applications such as an email application and/or an instant messaging (IM) application.

In various embodiments, the selection GUI presenting module 102′ of FIG. 3A is a logic module that may be designed to, among other things, present a selection GUI for selecting a level of access for accessing content 20 from a plurality of graduated levels of access for accessing the content, the plurality of graduated levels of access for accessing the content 20 being for accessing the content 20 with varying amounts of latency, the varying amounts of latency associated with the plurality of graduated levels of access for accessing the content 20 being further associated with varying amounts of corresponding (e.g., associated) fees. The selection obtaining module 104′ of FIG. 3A, on the other hand, is a logic module that may be configured to obtain from a content consumer a selection of the level of access for accessing the content 20 from the plurality of graduated levels of access to the content 20. In contrast, the content access presenting module 106′ of FIG. 3A is a logic module that may be configured to provide access to the content 20 following lapse of a latency associated with the selected level of access for accessing the content 20.

Turning now to FIG. 3B, which illustrates a block diagram of another computing device 10″ that can implement the operations and processes to be described herein. As indicated earlier, the computing device 10″ in FIG. 3B is merely the “soft” version of the computing device 10′ of FIG. 3A because the various logic modules: the selection GUI presenting module 102″, the selection obtaining module 104″, and the content access presenting module 106″ are implemented using software and one or more processors 116 (e.g., one or more microprocessors or controllers) executing the software (e.g., computer readable instructions 152) rather than being implemented using purely hardware (e.g., ASIC) as was the case in the computing device 10′ of FIG. 3A. Thus, the selection GUI presenting module 102″, the selection obtaining module 104″, and the content access presenting module 106″ of FIG. 3B may be designed to execute the same functions as the selection GUI presenting module 102′, the selection obtaining module 104′, and the content access presenting module 106′ of FIG. 3A. The computing device 10″, as illustrated in FIG. 3B, has other components (e.g., user interface 110, network interface 112, and so forth) that are the same or similar to the other components included in the computing device 10′ of FIG. 3A. Note that in the embodiment of the computing device 10* illustrated in FIG. 3B, the various logic modules (e.g., the selection GUI presenting module 102″, the selection obtaining module 104″, and the content access presenting module 106″) may be implemented by the one or more processors 116 (or other types of circuitry such as field programmable gate arrays or FPGAs) executing one or more computer readable instructions 152 stored in memory 114.

In various embodiments, the memory 114 of the computing device 10′ of FIG. 3A and the computing device 10″ of FIG. 3B may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

Turning now to FIG. 4A illustrating a particular implementation of the selection GUI presenting module 102* (e.g., the selection GUI presenting module 102′ or selection GUI presenting module 102″) of FIGS. 3A and 3B. As illustrated, the selection GUI presenting module 102* may include one or more sub-logic modules in various alternative implementations. For example, in various embodiments, the selection GUI presenting module 102* may include a slider feature presenting module 402 and/or an icon presenting module 404. Specific details related to the selection GUI presenting module 102* as well as the above-described sub-modules of the selection GUI presenting module 102* will be provided below with respect to the operations and processes to be described herein.

FIG. 4B illustrates a particular implementation of the selection obtaining module 104* (e.g., the selection obtaining module 104′ or the selection obtaining module 104″) of FIG. 3A or 3B. As illustrated, the selection obtaining module 104* in various alternative embodiments may include one or more sub-logic modules including a latency/fee selection obtaining module 406. Specific details related to the selection obtaining module 104*, as well as the above-described latency/fee selection obtaining module 406*, will be provided below with respect to the operations and processes to be described herein.

FIG. 4C illustrates a particular implementation of the content access presenting module 106* (e.g., the content access presenting module 106′ or the content access presenting module 106″) of FIG. 3A or 3B. As illustrated, the content access presenting module 106* may include one or more sub-logic modules in various alternative embodiments. For example, in various embodiments, the content access presenting module 106* may include a visual presenting module 408, an audio presenting module 410, a content obtaining module 412 (which may further include a request/solicitation relaying module 414), a selectable option presenting module 416 (which may further include an icon presenting module 418 and/or a link presenting module 420), and/or a contextual data presenting module 422 (which may further include a historical data presenting module 424). Specific details related to the content access presenting module 106*, as well as the above-described sub-modules of the content access presenting module 106*, will be provided below with respect to the operations and processes to be described herein.

A more detailed discussion related to the computing device 10* (e.g., the computing device 10′ of FIG. 3A or the computing device 10″ of FIG. 3B) discussed above will now be provided with respect to the processes and operations to be described herein. FIG. 5 illustrates an operational flow 500 representing example operations for, among other things providing a particular level of access to content from plurality of graduated levels of access to the content. In various implementations, these operations may be implemented by the computing device 10* of FIG. 3A or 3B.

In FIG. 5 and in the following figures that include various examples of operational flows, discussions and explanations will be provided with respect to the computing device 10* described above and as illustrated in FIGS. 3A, 3B, 4A, 4B, 4C, and/or with respect to other examples (e.g., as provided in FIGS. 1, 2A, 2B, 2C, 2D, 2E, 2F, 2G, 2H, 2J, 2K, and 2M) and contexts. However, it should be understood that the operational flows may be executed in a number of other environments and contexts, and/or in modified versions of FIGS. 1, 2A, 2B, 2C, 2D, 2E, 2F, 2G, 2H, 2J, 2K, 2M, 3A, 3B, 4A, 4B, and/or 4C. Also, although the various operational flows are presented in the sequence(s) illustrated, it should be understood that the various operations may be performed in other orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

More particularly, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated FIG. 5 as well as the other operations to be described herein may be performed by at least one of a machine or an article of manufacture.

In any event, after a start operation, the operational flow 500 of FIG. 5 may move to a selection GUI displaying operation 502 for displaying a selection graphical user interface (GUI) for selecting a level of access for accessing content from a plurality of graduated levels of access for accessing the content, the plurality of graduated levels of access for accessing the content being for accessing the content with varying amounts of latencies and for varying amounts of corresponding fees. For instance, and as illustration, the selection GUI presenting module 102* of the computing device 10* of FIG. 3A or 3B (e.g., the selection GUI presenting module 102′ of FIG. 3A or the selection GUI presenting module 102″ of FIG. 3B) displaying or visually presenting a selection GUI (e.g., selection GUI 200a, 200b, 200c, 200d, 200e, 200f, 200g, or 200h of FIG. 2A, 2B, 2C, 2D, 2E, 2F, 2G, or 2H) for selecting a level of access for accessing content 20 (e.g., financial news, celebrity news, commodity news, consumable media such as a movie, musical recording, or novel, and so forth) from a plurality of graduated levels of access for accessing the content 20, the plurality of graduated levels of access for accessing the content 20 being for accessing the content 20 with varying amounts of latencies (e.g., time delays) and for varying amounts of corresponding fees (e.g., the lower the latency the greater the corresponding fee).

Operational flow 500 may also include a selection receiving operation 504 for receiving a selection of the level of access for accessing the content from the plurality of graduated levels of access to the content. For instance, the selection obtaining module 104* (e.g., the selection obtaining module 104′ of FIG. 3A or the selection obtaining module 104″ of FIG. 3B) of the computing device 10* of FIG. 3A or 3B receiving or obtaining a selection (e.g., input received from a content consumer indicating a content access level selection) of the level of access (e.g., a particular level of latency and associated fee) for accessing the content 20 from the plurality of graduated levels of access (e.g., graduated levels of latencies and associated fees) to the content 20.

As further illustrated in FIG. 5, operational flow 500 may also include a content access providing operation 506 for providing access to the content in accordance with the selected level of access. For instance, the content access presenting module 106* (e.g., content access presenting module 106′ of FIG. 3A or the content access presenting module 106″ of FIG. 3B) providing access to the content 20 (e.g., displaying the content or presenting a link or an option to retrieve the content) in accordance with the selected level of access (e.g., selected level of latency and associated fee).

As will be described below, the selection GUI displaying operation 502, the selection receiving operation 504, and the content access providing operation 506 may be executed in a variety of different ways in various alternative implementations. FIGS. 6A, 6B, 6C, 6D, 6E, 6F, 6G, and 6H, for example, illustrates at least some of the alternative ways that the selection GUI displaying operation 502 of FIG. 5 may be executed in various alternative implementations. In some cases, for example, the selection GUI displaying operation 502 may include an operation 602 for displaying the selection GUI for selecting the level of access for accessing the content by displaying a slider feature for selecting the level of access for accessing the content from the plurality of graduated levels of access for accessing the content as illustrated in FIG. 6A. For instance, the selection GUI presenting module 102* including the slider feature presenting module 402 (see FIG. 4A) of the computing device 10* (e.g., the computing device 10′ of FIG. 3A or the computing device 10″ of FIG. 3B) displaying the selection GUI for selecting the level of access for accessing the content 20 when the slider feature presenting module 402 displays (e.g., visually presents) a slider feature (e.g., slider feature 201a, 201c, 201d, 201e, 201f, 201g, or 201h of FIG. 2A, 2C, 2D, 2E, 2F, 2G, or 2H) for selecting the level of access for accessing the content 20 from the plurality of graduated levels of access (e.g., graduated levels of latencies and corresponding or associated fees) for accessing the content 20.

As further illustrated in FIG. 6A, in some implementations, operation 602 may further involve or include an operation 603 for displaying the slider feature for selecting the level of access for accessing the content from the plurality of graduated levels of access for accessing the content by displaying a slider feature that includes a slider icon that is designed to be moveable, in response to user input, along length of an elongated element having a first end and a second end at opposite ends of the length of the elongated element, the slider icon being designed to be moved along the length of the elongated element from the first end to the second end to select the level of access for accessing the content. For instance, the slider feature presenting module 402 of the computing device 10* of FIG. 3A or 3B displaying (e.g., visually presenting) the slider feature for selecting the level of access for accessing the content 20 from the plurality of graduated levels of access for accessing the content 20 by displaying a slider feature 201a (see FIG. 2A) that includes a slider icon 202a (see FIG. 2A) that is designed to be moveable, in response to user input (e.g., user input as provided through a mouse or through a touchscreen), along length of an elongated element 204a (see FIG. 2A) having a first end 208a and a second end 210a at opposite ends of the length of the elongated element 204a, the slider icon 202a being designed to be moved along the length of the elongated element 204a from the first end 208a to the second end 210a to select the level of access (e.g., level of latency/fee) for accessing the content 20.

In some cases, operation 603 may further include or involve an operation 604 for displaying the slider feature that includes the slider icon that is designed to be moveable, in response to the user input, along the length of the elongated element having the first end and the second end by displaying a slider feature that includes the slider icon that is designed to be moveable, in response to the user input, along the length of the elongated element having multiple points along the length of the elongated element including the first end and the second end, the multiple points along the length of the elongated element from the first end to the second end being associated with graduated levels of access for accessing the content with varying amounts of latencies for accessing the content and varying amounts of corresponding fees, the first end corresponding to highest level of access that is available along the elongated element for accessing the content with lowest amount of latency and highest fee that are available along the elongated element and the second end corresponding to lowest access available along the elongated element for accessing the content with highest amount of latency and lowest fee that are available along the elongated element, and each point along the elongated element from the second end to the first end corresponding to incrementally increasing levels of access for accessing the content with decreasing amounts of latencies and increasing amounts of corresponding fees. For instance, the slider feature presenting module 402 of the computing device 10* of FIG. 3A or 3B displaying (e.g., visually presenting) the slider feature that includes the slider icon that is designed to be moveable, in response to the user input, along the length of the elongated element having the first end and the second end by displaying a slider feature 201a that includes the slider icon 202a that is designed to be moveable, in response to the user input, along the length of the elongated element 204a having multiple points 212a (e.g., multiple levels of content access) along the length of the elongated element 204a including the first end 208a and the second end 210a, the multiple points 212a along the length of the elongated element 204a from the first end 208a to the second end 210a being associated with graduated levels of access for accessing the content 20 with varying amounts of latencies (e.g., time delays) for accessing the content and varying amounts of corresponding fees, the first end 208a corresponding to highest level of access that is available along the elongated element 204a for accessing the content 20 with lowest amount of latency (e.g., smallest time delay) and highest fee that are available along the elongated element 204a and the second end 210a corresponding to lowest access available along the elongated element 204a for accessing the content 20 with highest amount of latency (e.g., biggest time delay) and lowest fee that are available along the elongated element 204a, and each point 212a along the elongated element 204a from the second end 210a to the first end 208a corresponding to incrementally increasing levels of access for accessing the content 20 with decreasing amounts of latencies and increasing amounts of corresponding fees.

In the same or alternative implementations, operation 603 may additionally or alternatively include an operation 605 for displaying the slider feature that includes the slider icon that is designed to be moveable, in response to the user input, along the length of the elongated element having the first end and the second end by displaying a slider feature that includes the slider icon that is designed to be moveable, in response to the user input, along the length of the elongated element having at least three points along the length of the elongated element including the first end, the second end, and at least a third point between the first end and the second end, each of the at least three points along the length of the elongated element from the first end to the second end being associated with a different level of access for accessing the content with a different amount of latency for accessing the content and different amount of corresponding fee as illustrated in FIG. 6B. For instance, the slider feature presenting module 402 of the computing device 10* of FIG. 3A or 3B displaying the slider feature that includes the slider icon that is designed to be moveable, in response to the user input, along the length of the elongated element having the first end and the second end by displaying a slider feature 201a (see FIG. 2A) that includes the slider icon 202a that is designed to be moveable, in response to the user input (e.g., a user using a mouse or the user's finger on a touchscreen to move the slider icon 202a), along the length of the elongated element 204a having at least three points along the length of the elongated element including the first end 208a, the second end 210a, and at least a third point between the first end 208a and the second end 210a, each of the at least three points along the length of the elongated element 204a from the first end 208a to the second end 210a being associated with a different level of access for accessing the content 20 with a different amount of latency for accessing the content 20 and different amount of corresponding fee (e.g., the smaller the latency the higher the fee).

In some cases, operation 605 may actually involve an operation 606 for displaying a slider feature that includes the slider icon that is designed to be moveable, in response to the user input, along the length of the elongated element having at least 10 points along the length of the elongated element including the first end and the second end, each of the at least 10 points along the length of the elongated element from the first end to the second end being associated with a different level of access for accessing the content with a different amount of latency for accessing the content and different amount of corresponding fee. For instance, the slider feature presenting module 402 of the computing device 10* of FIG. 3A or 3B displaying a slider feature 201a (see FIG. 2A) that includes the slider icon 202a that is designed to be moveable, in response to the user input, along the length of the elongated element 204a having at least 10 points 212a along the length of the elongated element 204a including the first end 208a and the second end 210a, each of the at least 10 points 212a along the length of the elongated element 204a from the first end 208a to the second end 210a being associated with a different level of access for accessing the content 20 with a different amount of latency for accessing the content 20 and different amount of corresponding fee.

In some implementations, operation 605 may actually involve an operation 607 for displaying a slider feature that includes the slider icon that is designed to be moveable, in response to the user input, along the length of the elongated element having at least 30 points along the length of the elongated element including the first end and the second end, each of the at least 30 points along the length of the elongated element from the first end to the second end being associated with a different level of access for accessing the content with a different amount of latency for accessing the content and different amount of corresponding fee. For instance, the slider feature presenting module 402 of the computing device 10* of FIG. 3A or 3B displaying a slider feature 201a that includes the slider icon 202a that is designed to be moveable, in response to the user input, along the length of the elongated element 204a having at least 30 points along the length of the elongated element 204a including the first end 208a and the second end 210a, each of the at least 30 points along the length of the elongated element 204a from the first end 208a to the second end 210a being associated with a different level of access for accessing the content 20 with a different amount of latency for accessing the content 20 and different amount of corresponding fee.

Turning now to FIG. 6C, in various implementations the selection GUI displaying operation 502 of FIG. 5 may actually include or involve an operation 608 for displaying the selection GUI for selecting the level of access for accessing the content by displaying a plurality of icons for selecting the level of access for accessing the content from the plurality of graduated levels of access for accessing the content, each icon to be displayed being associated with a different level of access for accessing the content with a different amount of latency for accessing the content and different amount of corresponding fee. For instance, the selection GUI presenting module 102* including the icon presenting module 404 (see FIG. 4A) of the computing device 10* of FIG. 3A or 3B displaying or visually presenting the selection GUI 200b (see FIG. 2B) for selecting the level of access for accessing the content 20 when the icon presenting module 404 displays (e.g., visually presents) a plurality of icons 220b (see FIG. 2B) for selecting the level of access for accessing the content 20 from the plurality of graduated levels of access for accessing the content 20, each icon 220b (e.g., icons in the shape of buttons) to be displayed being associated with a different level of access for accessing the content 20 with a different amount of latency for accessing the content 20 and different amount of corresponding fee. For example, each of the icons 220b in FIG. 2B is associated with a different amount of latency (e.g., 0 weeks, one week, two weeks, etc.) and a different amount of fee (e.g., $100, $90, $80, etc.). A user may be able to “select” any one of the icons 220b by “clicking” (e.g., clicking using a mouse) or touching (e.g., using a touchscreen) any of the icons 220b that may be displayed.

As further illustrated in FIG. 6C, operation 608 may include or involve one or more additional operations in various alternative implementations. For example, in some implementations, operation 608 may involve an operation 609 for displaying the plurality of icons for selecting the level of access for accessing the content from the plurality of graduated levels of access for accessing the content by displaying a plurality of button icons. For instance, the icon presenting module 404 of the computing device 10* of FIG. 3A or 3B displaying the plurality of icons 220b for selecting the level of access for accessing the content from the plurality of graduated levels of access for accessing the content 20 by displaying (e.g., visually presenting) a plurality of button icons (e.g., the icons 220b illustrated in FIG. 2B that can each be selected by “clicking” them). Note that although the icons 220b illustrated in FIG. 2B have rectangular shapes, in alternative implementations, the icons 220b may take on a variety of alternative shapes (e.g., circular or oval, square, and so forth).

In the same or alternative implementations, operation 608 may additionally or alternatively include an operation 610 for displaying the plurality of icons that includes at least three icons, each icon to be displayed being associated with a different level of access for accessing the content with a different amount of latency for accessing the content and a different amount of corresponding fee. For instance, the icon presenting module 404 of the computing device 10* of FIG. 3A or 3B displaying the plurality of icons 220b that includes at least three icons 220b, each icon 220b to be displayed being associated with a different level of access for accessing the content 20 with a different amount of latency for accessing the content and a different amount of corresponding fee. For example, FIG. 2B illustrates a plurality of icons 220b that are each associated with a different amount of latency (e.g., 0 weeks, 1 week, 2 weeks, etc.) and a different amount of associated fee (e.g., $100, $90, etc.)

In the same or alternative implementations, operation 608 may additionally or alternatively include an operation 611 for displaying the plurality of icons that includes at least ten icons, each icon to be displayed being associated with a different level of access for accessing the content with a different amount of latency for accessing the content and a different amount of corresponding fee. For instance, the icon presenting module 404 of the computing device 10* of FIG. 3A or 3B displaying the plurality of icons 220b that includes at least ten icons 220b, each icon 220b to be displayed being associated with a different level of access for accessing the content 20 with a different amount of latency for accessing the content 20 and a different amount of corresponding fee. Note that although the example illustrated in FIG. 2B include 11 icons 220b in alternative implementations, fewer or greater amounts of icons 220b may be employed.

Referring now to FIG. 6D, in various implementation, the selection GUI displaying operation 502 of FIG. 5 may include or involve an operation 612 for displaying the selection GUI for selecting the level of access for accessing the content from the plurality of graduated levels of access for accessing the content by displaying a selection GUI for selecting a level of access for accessing the content from at least three graduated levels of access for accessing the content, the at least three graduated levels of access for accessing the content corresponding to three different amounts of latencies and three different amounts of corresponding fees. For instance, the selection GUI presenting module 102* of the computing device 10* of FIG. 3A or 3B displaying the selection GUI for selecting the level of access for accessing the content 20 from the plurality of graduated levels of access for accessing the content 20 by displaying (e.g., visually presenting) a selection GUI 200c (e.g., slider feature 201c of FIG. 2C) for selecting a level of access for accessing the content 20 from at least three graduated levels of access 212c for accessing the content 20, the at least three graduated levels of access 212c for accessing the content 20 corresponding to three different amounts of latencies (e.g., 1 second, 100 microsecond, 1 microsecond, etc.) and three different amounts of corresponding fees (e.g., 10 thousand dollars, 50 thousand dollars, and $280 thousand dollars, etc.).

In some implementations, the selection GUI displaying operation 502 of FIG. 5 may include an operation 613 for displaying the selection GUI for selecting the level of access for accessing the content from the plurality of graduated levels of access for accessing the content by displaying a selection GUI for selecting a level of access for accessing the content from at least ten graduated levels of access for accessing the content, the at least ten graduated levels of access for accessing the content corresponding to ten different amounts of latencies and ten different amounts of corresponding fees. For instance, the selection GUI presenting module 102* of the computing device 10* of FIG. 3A or 3B displaying the selection GUI for selecting the level of access for accessing the content 20 from the plurality of graduated levels of access for accessing the content 20 by displaying (e.g., visually presenting) a selection GUI 200c (e.g., slider feature 201c of FIG. 2C) for selecting a level of access for accessing the content 20 from at least ten graduated levels of access 212c for accessing the content 20, the at least ten graduated levels of access 212c for accessing the content corresponding to ten different amounts of latencies and ten different amounts of corresponding fees.

In some implementations, the selection GUI displaying operation 502 may additionally or alternatively include an operation 614 for displaying the selection GUI for selecting the level of access for accessing content from the plurality of graduated levels of access for accessing the content, the plurality of graduated levels of access for accessing the content being for accessing the content with the varying amounts of latencies and for the varying amounts of corresponding fees, the plurality of graduated levels of access further for accessing varying amounts of contextual data. For instance, the selection GUI presenting module 102* of the computing device 10* of FIG. 3A or 3B displaying the selection GUI 200c (e.g., the slider feature 201c of FIG. 2C or the plurality of icons 220b of FIG. 2B) for selecting the level of access for accessing content 20 from the plurality of graduated levels of access 212c (see FIG. 2C) for accessing the content 20, the plurality of graduated levels of access 205c for accessing the content 20 being for accessing the content 20 with the varying amounts of latencies and for the varying amounts of corresponding fees, the plurality of graduated levels of access 212c further for accessing varying amounts of contextual data (e.g., historical or background information related to the content 20, which may be obtained from the source that the content 20 is obtained from or from one or more other sources).

In some cases, operation 614 may actually involve an operation 615 for displaying the selection GUI for selecting the level of access for accessing content from the plurality of graduated levels of access for accessing the content including for accessing the varying amounts of contextual data by displaying a selection GUI for selecting a level of access for accessing content from a plurality of graduated levels of access for accessing the content including for accessing varying amounts of contextual data, wherein the greatest level of access to the content available through the selection GUI providing greatest amount of contextual data available through the selection GUI and wherein the lowest level of access available through the selection GUI providing lowest amount of contextual data available through the selecting feature. For instance, the selection GUI presenting module 102* of the computing device 10* of FIG. 3A or 3B displaying the selection GUI for selecting the level of access for accessing content 20 from the plurality of graduated levels of access for accessing the content 20 including for accessing the varying amounts of contextual data by displaying (e.g., visually presenting) a selection GUI 200c (e.g., the slider feature 201c of FIG. 2C) for selecting a level of access for accessing content 20 from a plurality of graduated levels of access 212c (see FIG. 2C) for accessing the content 20 including for accessing varying amounts of contextual data (e.g., historical market or financial data or movie trailers), wherein the greatest level of access to the content 20 available through the selection GUI 200c (e.g., the slider feature 201c of FIG. 2C) providing greatest amount of contextual data available through the selection GUI 200c (e.g., the slider feature 201c of FIG. 2C) and wherein the lowest level of access available through the selection GUI 200c (e.g., the slider feature 201c of FIG. 2C) providing lowest amount of contextual data available through the selecting feature.

In the same or alternative implementations, operation 614 may additionally or alternatively include an operation 616 for displaying the selection GUI for selecting the level of access for accessing content from the plurality of graduated levels of access for accessing the content including for accessing the varying amounts of contextual data by displaying a selection GUI for selecting a level of access for accessing content from a plurality of graduated levels of access for accessing the content including for accessing varying amounts of contextual data provided from varying amounts of contextual sources, wherein the greatest level of access available through the selection GUI providing contextual data from greatest number of contextual sources and wherein the lowest level of access available through the selection GUI providing contextual data from lowest number of contextual sources. For instance, the selection GUI presenting module 102* of the computing device 10* of FIG. 3A or 3B displaying the selection GUI for selecting the level of access for accessing content 20 from the plurality of graduated levels of access for accessing the content 20 including for accessing the varying amounts of contextual data by displaying (e.g., visually presenting) a selection GUI 200c or 200b (e.g., the slider feature 201c of FIG. 2C or the plurality of icons 220b of FIG. 2B) for selecting a level of access for accessing content 20 from a plurality of graduated levels of access (e.g., levels of access 212c) for accessing the content 20 including for accessing varying amounts of contextual data (e.g., historical market or financial data or movie trailers) provided from varying amounts of contextual sources, wherein the greatest level of access available through the selection GUI 200c or 200b (e.g., the slider feature 201c of FIG. 2C or the plurality of icons 220b of FIG. 2B) providing contextual data from greatest number of contextual sources (e.g., Dow Jones, Nasdaq, Associated Press, Reuters, HBO, Disney, Columbia Pictures, etc.) and wherein the lowest level of access available through the selection GUI providing contextual data from lowest number of contextual sources.

In various implementations, the display of the selection GUI may be in response to reception of certain information related to the content. For example, and as illustrated in FIG. 6E, the selection GUI displaying operation 502 of FIG. 5 in some implementations may include an operation 617 for displaying the selection GUI for selecting the level of access for accessing the content from the plurality of graduated levels of access for accessing the content in response to receiving one or more bidding tags providing at least summary information that summarizes the content. For instance, the selection GUI presenting module 102* of the computing device 10* of FIG. 3A or 3B displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) for selecting the level of access for accessing the content 20 from the plurality of graduated levels of access for accessing the content 20 in response to receiving one or more bidding tags 30 providing at least summary information (e.g., name of a stock, date, name of a movie, etc.) that summarizes the content 20.

As further illustrated in FIG. 6E, operation 617 may include one or more additional operations including in some implementations, for example, an operation 618 for displaying the selection GUI in response to receiving the one or more bidding tags by displaying the selection GUI in response to receiving one or more bidding tags providing selective information from the content, the selective information to be provided through the one or more bidding tags comprising less than 30 percent of data associated with the content. For instance, the selection GUI presenting module 102* of the computing device 10* of FIG. 3A or 3B displaying the selection GUI in response to receiving the one or more bidding tags 30 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information (e.g., name of a movie, a movie trailer, type of news such as celebrity news, name of a publically traded company, and so forth) to be provided through the one or more bidding tags 30 comprising less than 30 percent of data associated with the content 20.

In some implementations, operation 617 may involve an operation 619 for displaying the selection GUI in response to receiving the one or more bidding tags by displaying the selection GUI in response to receiving one or more bidding tags providing selective information from the content, the selective information to be provided through the one or more bidding tags comprising less than 5 percent of data associated with the content. For instance, the selection GUI presenting module 102* of the computing device 10* of FIG. 3A or 3B displaying the selection GUI in response to receiving the one or more bidding tags 30 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information (e.g., name of a celebrity, name of a movie, movie trailer, date associated with a stock price, etc.) to be provided through the one or more bidding tags 30 comprising less than 5 percent of data associated with the content 20.

In some implementations, operation 617 may involve an operation 620 for displaying the selection GUI in response to receiving the one or more bidding tags by displaying the selection GUI in response to receiving one or more bidding tags providing selective information from the content, the selective information to be provided through the one or more bidding tags comprising less than 1 percent of data associated with the content. For instance, the selection GUI presenting module 102* of the computing device 10* of FIG. 3A or 3B displaying the selection GUI in response to receiving the one or more bidding tags 30 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information to be provided through the one or more bidding tags 30 comprising less than 1 percent of data associated with the content 20.

In the same or different implementations, operation 617 may additionally or alternatively include an operation 621 for displaying the selection GUI in response to receiving the one or more bidding tags by displaying the selection GUI in response to receiving one or more bidding tags providing selective information from the content, the selective information to be provided through the one or more bidding tags identifying at least type of news provided by the content. For instance, the selection GUI presenting module 102* of the computing device 10* of FIG. 3A or 3B displaying the selection GUI in response to receiving the one or more bidding tags 30 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information to be provided through the one or more bidding tags 30 identifying at least type of news (e.g., Financial news, crop or agricultural news, celebrity news, etc.) provided by the content 20.

In some implementations, operation 617 may include an operation 622 for displaying the selection GUI in response to receiving the one or more bidding tags by displaying the selection GUI in response to receiving one or more bidding tags providing selective information from the content, the selective information to be provided through the one or more bidding tags identifying consumable media provided by the content. For instance, the selection GUI presenting module 102* of the computing device 10* of FIG. 3A or 3B displaying the selection GUI in response to receiving the one or more bidding tags 30 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information to be provided through the one or more bidding tags 30 identifying consumable media (e.g., a movie, a documentary, an athletic or sporting event, an audio recording, a digital book such as a novel, and so forth) provided by the content 20.

As further illustrated in FIG. 6E, in some cases, operation 622 may further include or involve an operation 623 for displaying the selection GUI in response to receiving one or more bidding tags that identifies the consumable media provided by the content by displaying the selection GUI in response to receiving one or more bidding tags providing selective information from the content, the selective information to be provided through the one or more bidding tags identifying at least a name of a textual document, a video, or an audio recording provided by the content. For instance, the selection GUI presenting module 102* of the computing device 10* of FIG. 3A or 3B displaying the selection GUI in response to receiving one or more bidding tags 30 that identifies the consumable media provided by the content 20 by displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) in response to receiving one or more bidding tags 30 providing selective information from the content 20, the selective information to be provided through the one or more bidding tags 30 identifying at least a name (e.g., title) of a textual document (e.g., a digital book such as a novel or an exposé article), a video (e.g., a movie, a TV show, a documentary, a sport event recording, etc.), or an audio recording (e.g., music, a recording of a speech or a seminary, etc.) provided by the content 20.

In some implementations, the selection GUI displaying operation 502 of FIG. 5 may include or involve an operation 624 for displaying the selection GUI for selecting the level of access for accessing the content from the plurality of graduated levels of access for accessing the content in response to receiving data for generating the selection GUI as illustrated in FIG. 6F. For instance, the selection GUI presenting module 102* of the computing device 10* of FIG. 3A or 3B displaying the selection GUI (e.g., selection GUI 200a, 200b, 200c, 200d, 200e, 200f, 200g, or 200h of FIG. 2A, 2B, 2C, 2D, 2E, 2F, 2G, or 2H) for selecting the level of access for accessing the content 20 from the plurality of graduated levels of access for accessing the content 20 in response to receiving data for generating the selection GUI. In some cases, the data used to generate the selection GUI may be included in one or more bidding tags 30.

In the same or different implementations, the selection GUI displaying operation 502 of FIG. 5 may additionally or alternatively include an operation 625 for displaying the selection GUI by displaying a selection GUI that at least identifies the type of content that is to be accessed. For instance, the selection GUI presenting module 102* of the computing device 10* of FIG. 3A or 3B displaying the selection GUI by displaying (e.g., visually presenting) a selection GUI (e.g., selection GUI 200a, 200b, 200c, 200d, 200e, 200f, 200g, or 200h of FIG. 2A, 2B, 2C, 2D, 2E, 2F, 2G, or 2H) that at least identifies the type of content 20 that is to be accessed. For example, identifying that the content 20 is news and if so, identifying the type of news (e.g., financial market news, governmental news, celebrity news, etc.).

In some implementations, operation 625 may further include an operation 626 for displaying the selection GUI that at least identifies the type of content that is to be accessed by displaying a selection GUI that does not disclose one or more essential elements of the content to be accessed. For instance, the selection GUI presenting module 102* of the computing device 10* of FIG. 3A or 3B displaying the selection GUI that at least identifies the type of content that is to be accessed by displaying (e.g., visually presenting) a selection GUI (e.g., selection GUI 200a, 200b, 200c, 200d, 200e, 200f, 200g, or 200h of FIG. 2A, 2B, 2C, 2D, 2E, 2F, 2G, or 2H) that does not disclose one or more essential elements of the content 20 to be accessed. For example, if the content 20 is financial news than displaying a selection GUI that does not disclose financial data disclosed in the content 20).

As further illustrated in FIG. 6F, operation 626 may further include one or more additional operations in various alternative implementations. For example, in some implementations, operation 626 may include an operation 627 for displaying the selection GUI that does not disclose the one or more essential elements of the content to be accessed by displaying a selection GUI that does not disclose numerical data provided by the content, the content being financial and/or market news. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200a (e.g., the slider feature 201a of FIG. 2A) that does not disclose numerical data (e.g., stock or commodity pricing on a particular day/time) provided by the content 20, the content 20 being financial and/or market news. For example, displaying a selection GUI that identifies a particular fortune 500 company without identifying the latest prices of the stocks of the fortunate 500 company.

In the same or alternative implementations, operation 626 may additionally or alternatively include an operation 628 for displaying the selection GUI that does not disclose the one or more essential elements of the content to be accessed by displaying a selection GUI that does not disclose crop data provided by the content, the content being agricultural news. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200g (e.g., slider feature 201g of FIG. 2G) that does not disclose crop data provided by the content 20, the content 20 being agricultural news.

In the same or alternative implementations, operation 626 may additionally or alternatively include an operation 629 for displaying the selection GUI that does not disclose the one or more essential elements of the content to be accessed by displaying a selection GUI that does not disclose numerical data provided by the content, the content being commodities news. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200g (e.g., the slider feature 201g of FIG. 2G) that does not disclose numerical data provided by the content 20, the content 20 being commodities news (e.g., crop prices, energy prices, and so forth).

In the same or alternative implementations, operation 626 may additionally or alternatively include an operation 630 for displaying the selection GUI that does not disclose the one or more essential elements of the content to be accessed by displaying a selection GUI that does not specifically identify one or more persons, the content being news related to the one or more persons. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200e (e.g., slider feature 201e of FIG. 2E) that does not specifically identify one or more persons (e.g., a celebrity), the content 20 being news related to the one or more persons. Note that for these implementations, the one or more persons may, nonetheless, be indirectly identified in the selection GUI (e.g., identifying the person as a “celebrity” or as a “government official” or a “professional athlete” without specifically identifying the person).

In the same or alternative implementations, operation 626 may additionally or alternatively include an operation 631 for displaying the selection GUI that does not disclose the one or more essential elements of the content to be accessed by displaying a selection GUI that identifies one or more persons but does not specifically disclose news related to the one or more persons, the content being the news related to the one or more persons. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200f (e.g., the slider feature 201f of FIG. 2F) that identifies one or more persons but does not specifically disclose news related to the one or more persons (e.g., “Lindsey Lohan”), the content 20 being the news related to the one or more persons.

In the same or alternative implementations, operation 626 may additionally or alternatively include an operation 632 for displaying the selection GUI that does not disclose the one or more essential elements of the content to be accessed by displaying a selection GUI that does not specifically disclose news related to one or more government or private entities, the content being the news related to the one or more government or private entities. For instance, the selection GUI presenting module 102* of the computing device 10* of FIG. 3A or 3B displaying the selection GUI that does not disclose the one or more essential elements of the content to be accessed by displaying (e.g., visually presenting) a selection GUI 200h (e.g., the slider feature 201h of FIG. 2H) that does not specifically disclose news related to one or more government or private entities (e.g. Federal Trade Commission, Federal Reserve, and so forth), the content 20 being the news related to the one or more government or private entities.

In the same or alternative implementations, operation 626 may additionally or alternatively include an operation 633 for displaying the selection GUI that does not disclose the one or more essential elements of the content to be accessed by displaying a selection GUI that does not disclose most of the content as illustrated in FIG. 6G. For instance, the selection GUI presenting module 102* of the computing device 10* of FIG. 3A or 3B displaying the selection GUI that does not disclose the one or more essential elements of the content 20 to be accessed by displaying (e.g., visually presenting) a selection GUI 200d (e.g., slider feature 201d of FIG. 2D) that does not disclose most of the content 20 (e.g., a digital version of a feature film).

In some implementations, operation 633 may actually involve an operation 634 for displaying the selection GUI that does not disclose most of the content by displaying a selection GUI that discloses less than five percent of the content. For instance, the selection GUI presenting module 102* of the computing device 10* of FIG. 3A or 3B displaying the selection GUI that does not disclose most of the content by displaying (e.g., visually presenting) a selection GUI 200d (e.g., the slider feature 201d of FIG. 2D) that discloses less than five percent of the content 20.

In some implementations, operation 633 may actually involve an operation 635 for displaying the selection GUI that does not disclose most of the content, the content being a movie. For instance, the selection GUI presenting module 102* of the computing device 10* of FIG. 3A or 3B displaying the selection GUI 200d (e.g., the slider feature 201d of FIG. 2D) that does not disclose most of the content 20, the content 20 being a digital version of a movie (e.g., a theatrical film).

In various implementations, the selection GUI displaying operation 502 of FIG. 5 may include an operation 636 for displaying the selection GUI for selecting the level of access for accessing the content from the plurality of graduated levels of access for accessing the content by displaying a selection GUI for selecting the level of access for accessing the content from a plurality of indicated graduated levels of access for accessing the content. For instance, the selection GUI presenting module 102* of the computing device 10* of FIG. 3A or 3B displaying the selection GUI for selecting the level of access for accessing the content 20 from the plurality of graduated levels of access for accessing the content 20 by displaying (e.g., visually presenting) a selection GUI 200a (e.g., slider feature 201a of FIG. 2A) for selecting the level of access for accessing the content 20 from a plurality of indicated graduated levels 212a (see FIG. 2A) of access for accessing the content 20.

In various implementations, operation 636 may further include an operation 637 for displaying the selection GUI for selecting the level of access for accessing the content from the plurality of indicated graduated levels of access for accessing the content by displaying a selection GUI for selecting the level of access, the selection GUI indicating graduated amounts of latencies associated with the graduated levels of access for accessing the content. For instance, the selection GUI presenting module 102* of the computing device 10* of FIG. 3A or 3B displaying the selection GUI for selecting the level of access for accessing the content from the plurality of indicated graduated levels of access for accessing the content by displaying (e.g., visually presenting) a selection GUI 200c (e.g., slider feature 201c of FIG. 2C) for selecting the level of access, the selection GUI indicating graduated amounts of latencies (e.g., 1 second, 100 microseconds, and so forth) associated with the graduated levels of access for accessing the content 20.

In the same or alternative implementations, operation 636 may additionally or alternatively include an operation 638 for displaying the selection GUI for selecting the level of access for accessing the content from the plurality of indicated graduated levels of access for accessing the content by displaying a selection GUI for selecting the level of access, the selection GUI indicating graduated amounts of fees associated with the graduated levels of access for accessing the content. For instance, the selection GUI presenting module 102* of the computing device 10* of FIG. 3A or 3B displaying the selection GUI for selecting the level of access for accessing the content from the plurality of indicated graduated levels of access for accessing the content by displaying (e.g., visually presenting) a selection GUI 200c (e.g., slider feature 201c of FIG. 2C) for selecting the level of access, the selection GUI indicating graduated amounts of fees (inversely) associated with the graduated levels of access for accessing the content 20. Note that in various implementations, the graduated amounts of fees indicated by the selection GUI may be inversely associated with the graduated levels of access (e.g., latencies) for accessing the content 20. For example, higher fees being associated with lower latencies.

Referring to FIG. 6H, in various implementations, the selection GUI displaying operation 502 of FIG. 5 may include an operation 639 for displaying the selection GUI for selecting the level of access for accessing the content from the plurality of graduated levels of access for accessing the content, the plurality of graduated levels of access for accessing the content being for accessing the content with varying amounts of latencies for accessing the content, a latency for accessing the content being an amount of time between an earliest point in time in which the content is publicly available and the point in time in which the content actually becomes accessible. For instance, the selection GUI presenting module 102* of the computing device 10* of FIG. 3A or 3B displaying (e.g., visually presenting) the selection GUI 200a (e.g., slider feature 201a of FIG. 2A) for selecting the level of access for accessing the content 20 from the plurality of graduated levels of access for accessing the content, the plurality of graduated levels of access for accessing the content 20 being for accessing the content 20 with varying amounts of latencies for accessing the content 20, a latency for accessing the content 20 being an amount of time between an earliest point in time in which the content 20 (e.g., general news or information provided through social media) is publicly available and the point in time in which the content 20 actually becomes accessible.

In some implementations, the selection GUI displaying operation 502 of FIG. 5 may include an operation 640 for displaying the selection GUI for selecting the level of access for accessing the content from the plurality of graduated levels of access for accessing the content, the plurality of graduated levels of access for accessing the content being for accessing the content with varying amounts of latencies for accessing the content, a latency for accessing the content being an amount of time between a point in time in which the content comes into existence and the point in time in which the content actually becomes accessible. For instance, the selection GUI presenting module 102* of the computing device 10* of FIG. 3A or 3B displaying (e.g., visually presenting) the selection GUI (e.g., selection GUI 200a, 200b, 200c, 200d, 200e, 200f, 200g, or 200h of FIG. 2A, 2B, 2C, 2D, 2E, 2F, 2G, or 2H) for selecting the level of access for accessing the content 20 from the plurality of graduated levels of access for accessing the content 20, the plurality of graduated levels of access for accessing the content 20 being for accessing the content 20 with varying amounts of latencies for accessing the content 20, a latency for accessing the content 20 being an amount of time between a point in time in which the content 20 (e.g., financial or market news) comes into existence (e.g., earliest point in time that the content 20 can be made available) and the point in time in which the content 20 actually becomes accessible or available.

In some implementations, the selection GUI displaying operation 502 of FIG. 5 may include an operation 641 for displaying the selection GUI for selecting the level of access for accessing the content from the plurality of graduated levels of access for accessing the content by displaying a selection GUI for selecting the level of access for accessing the content, the selection GUI further providing an option to be provided with information indicating who, when, and/or how many users have already previously accessed the content. For instance, the selection GUI presenting module 102* of the computing device 10* of FIG. 3A or 3B displaying the selection GUI for selecting the level of access for accessing the content 20 from the plurality of graduated levels of access for accessing the content 20 by displaying (e.g., visually presenting) a selection GUI 200a (e.g., slider feature 201a of FIG. 2A) for selecting the level of access for accessing the content 20, the selection GUI further providing an option to be provided with information indicating who, when, and/or how many users have already previously accessed the content 20. For example, included in the example selection GUI 200a (e.g., slider feature 201a) of FIG. 2A is an icon 207a, which may be “clicked” by a user in order to obtain previous viewer information related to information (e.g., who, when, and/or how many) of users who previously viewed or accessed the content.

In some implementations, the selection GUI displaying operation 502 of FIG. 5 may include an operation 642 for displaying the selection GUI for selecting the level of access for accessing the content from the plurality of graduated levels of access for accessing the content by displaying a selection GUI for selecting the level of access for accessing the content, the selection GUI further providing information indicating who, when, and/or how many users have already previously accessed the content. For instance, the selection GUI presenting module 102* of the computing device 10* of FIG. 3A or 3B displaying the selection GUI for selecting the level of access for accessing the content 20 from the plurality of graduated levels of access for accessing the content 20 by displaying (e.g., visually presenting) a selection GUI 200c (e.g., the slider feature 201c of FIG. 2C) for selecting the level of access for accessing the content 20, the selection GUI further providing information indicating who, when, and/or how many users have already previously accessed the content 20. For example, in the example selection GUI (e.g., selection GUI 200c) illustrated in FIG. 2C includes a textual information 209c that indicates information of users who have previously accessed the content 20 has been included.

Referring back to the selection receiving operation 504 of FIG. 5, the selection receiving operation 504 similar to selection GUI displaying operation 502 of FIG. 5 may be executed in a number of different ways in various alternative embodiments as illustrated in FIG. 7. In some implementations, for example, the selection receiving operation 504 may include an operation 743 for receiving the selection of the level of access for accessing the content by receiving the selection via a user interface. For instance, the selection obtaining module 104* of the computing device 10* of FIG. 3A or 3B receiving the selection of the level of access for accessing the content 20 by receiving (e.g., obtaining) the selection directly via a user interface.

As further illustrated in FIG. 7, in some implementations operation 743 may further include an operation 744 for receiving the selection via the user interface by receiving the selection via a keyboard or keypad, a mouse, a microphone, or a touchscreen. For instance, the selection obtaining module 104* of the computing device 10* of FIG. 3A or 3B receiving the selection (e.g., user input) via the user interface 110 by receiving (e.g., obtaining) the selection via a keyboard or keypad, a mouse, a microphone, or a touchscreen.

In the same or different implementations, the selection receiving operation 504 may additionally or alternatively include an operation 745 for receiving the selection of the level of access for accessing the content by receiving a selection for a particular amount of latency and a particular amount of fee associated with the particular amount of latency. For instance, the selection obtaining module 104* including the latency/fee selection obtaining module 406 (see FIG. 4B) of the computing device 10* of FIG. 3A or 3B receiving the selection of the level of access for accessing the content 20 when the latency/fee selection obtaining module 406 receives or obtains a selection (e.g., a bid 40) for a particular amount of latency and a particular amount of fee associated with the particular amount of latency. In some cases, the selection or bid 40 for a particular amount of latency/fee may be further relayed to one or more content sources 60 in order to obtain and present the content in accordance with the selected latency.

In the same or different implementations, the selection receiving operation 504 may additionally or alternatively include an operation 746 for receiving the selection of the level of access for accessing the content by receiving a selection that identifies the content to be accessed. For instance, the selection obtaining module 104* of the computing device 10* of FIG. 3A or 3B receiving the selection of the level of access for accessing the content 20 by receiving (e.g., obtaining) a selection (e.g., a bid 40) that identifies the content 20 to be accessed. For example, when a user selects a content 20 to access with a particular amount of latency/fee, the user may further indicate or identify the content 20 to be accessed.

In the same or different implementations, the selection receiving operation 504 may additionally or alternatively include an operation 747 for receiving the selection of the level of access for accessing the content, the received selection including an election to receive information indicating who, when, and/or how many users have already previously accessed the content. For instance, the selection obtaining module 104* of the computing device 10* of FIG. 3A or 3B receiving the selection (e.g., bid 40) of the level of access for accessing the content 20, the received selection including an election to receive information (e.g., previous viewer information 22 of FIG. 1) indicating who, when, and/or how many users have already previously accessed the content 20.

In the same or different implementations, the selection receiving operation 504 may additionally or alternatively include an operation 748 for receiving the selection of the level of access for accessing the content, the received selection including an election to acquire the content through one or more particular communication links. For instance, the selection obtaining module 104* of the computing device 10* of FIG. 3A or 3B receiving or obtaining the selection (e.g., a bid 40) of the level of access for accessing the content 20, the received or obtained selection including an election to acquire the content 20 through one or more particular communication links (e.g., selection or election of a particular communication link such as a cellular data network that has a particular bandwidth).

Referring back to the content access providing operation 506 of FIG. 5, the content access providing operation 506 similar to the selection GUI displaying operation 502 and the selection receiving operation 504 of FIG. 5 may be executed in a number of different ways in various alternative embodiments as illustrated in FIGS. 8A, 8B, 8C, and 8D. In some implementations, for example, the content access providing operation 506 may include an operation 849 for providing the access to the content by visually displaying the content. For instance, the content access presenting module 106* including the visual presenting module 408 (see FIG. 4C) of the computing device 10* of FIG. 3A or 3B providing the access to the content 20 when the visual presenting module 408 visually displays (e.g., visually presenting) the content 20 via one or more displays (e.g., a touchscreen, a LCD, and so forth).

In the same or alternative implementations, the content access providing operation 506 may additionally or alternatively include or involve an operation 850 for providing the access to the content by audibly presenting the content. For instance, the content access presenting module 106* including the audio presenting module 410 (see FIG. 4C) of the computing device 10* of FIG. 3A or 3B providing the access to the content 20 when the audio presenting module 410 audibly presents the content 20 (e.g., an audio recording).

In the same or alternative implementations, the content access providing operation 506 may additionally or alternatively include or involve an operation 851 for providing the access to the content by acquiring the content via one or more wireless and/or wired networks in response, at least in part, to said receiving of the selection. For instance, the content access presenting module 106* including the content obtaining module 412 (see FIG. 4C) of the computing device 10* of FIG. 3A or 3B providing (e.g., visually presenting) the access to the content 20 when the content obtaining module 412 acquires (obtains) the content 20 via one or more wireless and/or wired networks 5 in response, at least in part, to said receiving of the selection of the level of access for accessing the content.

In some implementations, operation 851 may further include an operation 852 for acquiring the content via the one or more wireless and/or wired networks in response, at least in part, to said receiving by transmitting one or more requests and/or solicitations for acquiring the content in response, at least in part, to said receiving the selection. For instance, the content obtaining module 412 including the request/solicitation relaying module 414 (see FIG. 4C) of the computing device 10* of FIG. 3A or 3B acquiring the content 20 via the one or more wireless and/or wired networks 5 in response, at least in part, to said receiving when the request/solicitation relaying module 414 transmits or relays one or more requests and/or solicitations (e.g., bids 40) for acquiring the content 20 in response, at least in part, to said receiving the selection.

In the same or alternative implementations, the content access providing operation 506 may additionally or alternatively include or involve an operation 853 for providing the access to the content by displaying a user selectable option for audibly and/or visually presenting the content upon a user selecting the option. For instance, the content access presenting module 106* including the selectable option presenting module 416 (see FIG. 4C) of the computing device 10* of FIG. 3A or 3B providing the access to the content when the selectable option presenting module 416 displays (e.g., presents) a user selectable option (e.g., icon 220k of FIG. 2K) for audibly and/or visually presenting the content 20 upon a user selecting (e.g., “clicking”) the option (e.g., icon 220K).

In some implementations, operation 853 may further include an operation 854 for displaying the user selectable option for audibly and/or visually presenting the content by displaying an icon for retrieving and/or displaying the content. For instance, the selectable option presenting module 416 including the icon presenting module 418 (see FIG. 4C) of the computing device 10* of FIG. 3A or 3B displaying the user selectable option for audibly and/or visually presenting the content when the icon presenting module 418 displays (e.g., visually presenting) an icon 220k (see FIG. 2K) for retrieving and/or displaying the content 20.

In some implementations, operation 853 may additionally or alternatively include an operation 855 for displaying the user selectable option for audibly and/or visually presenting the content by displaying a link for retrieving and audibly and/or visually presenting the content. For instance, the selectable option presenting module 416 including the link presenting module 420 (see FIG. 4C) of the computing device 10* of FIG. 3A or 3B displaying the user selectable option for audibly and/or visually presenting the content 20 when the link presenting module 420 displays (e.g., visually presenting) a link 221m (e.g., hyperlink) for retrieving and audibly and/or visually presenting the content 20.

In the same or alternative implementations, the content access providing operation 506 may additionally or alternatively include an operation 856 for providing the access to the content in accordance with the selected level of access by providing the access to the content following lapse of a latency associated with the selected level of access. For instance, the content access presenting module 106*of the computing device 10* of FIG. 3A or 3B providing the access to the content 20 in accordance with the selected level of access by providing the access (e.g., visually or audibly presenting the content) to the content 20 following lapse of a latency (e.g., 1 microsecond, 100 microseconds, 1 second, 1 minute, 5 minutes, 1 hour, 1 day, 5 days, and so forth) associated with the selected level of access. In some implementations, the content access presenting module 106* may be designed to retrieve the content 20 only after lapse of a time interval associated with the latency associated with the selected level of access.

In some implementations, operation 856 may further include an operation 857 for providing the access to the content following the lapse of the latency associated with the selected level of access by providing the access to the content following lapse of a period of time associated with the latency, the lapse of the period of time being lapse of a time span immediately following earliest point in time in which the content is publicly available. For instance, the content access presenting module 106*of the computing device 10* of FIG. 3A or 3B providing the access to the content 20 following the lapse of the latency associated with the selected level of access by providing (e.g., presenting) the access to the content 20 following lapse of a period of time (e.g., time interval) associated with the latency, the lapse of the period of time (e.g., time interval) being lapse of a time span immediately following earliest point in time in which the content is publicly available (e.g., earliest point in time that the content is released to the public).

In some implementations, operation 856 may additionally or alternatively include an operation 858 for providing the access to the content following the lapse of the latency associated with the selected level of access by providing the access to the content following lapse of a period of time associated with the latency, the lapse of the period of time being lapse of a time span immediately following earliest point in time in which the content comes into existence. For instance, the content access presenting module 106*of the computing device 10* of FIG. 3A or 3B providing the access to the content 20 following the lapse of the latency associated with the selected level of access by providing (e.g., presenting) the access to the content 20 following lapse of a period of time (e.g., time interval) associated with the latency, the lapse of the period of time (e.g., time interval) being lapse of a time span immediately following earliest point in time in which the content comes into existence (e.g., the earliest point in time in which a news item comes into existence such as a stock or commodity news).

In the same or alternative implementations, the content access providing operation 506 may additionally or alternatively include an operation 859 for providing the access to the content in accordance with the selected level of access by providing the access to the content following lapse of a latency associated with the selected level of access, the lapse of latency being lapse of less than one second as illustrated in FIG. 8B. For instance, the content access presenting module 106* of the computing device 10* of FIG. 3A or 3B providing the access to the content 20 in accordance with the selected level of access by providing (e.g., presenting) the access to the content 20 following lapse of a latency associated with the selected level of access, the lapse of latency being lapse of less than one second (e.g., lapse of less than one second following the point in time that is the earliest point in time in which the content 20 may be made available).

In the same or alternative implementations, the content access providing operation 506 may additionally or alternatively include an operation 860 for providing the access to the content in accordance with the selected level of access by providing the access to the content following lapse of a latency associated with the selected level of access, the lapse of latency being lapse of greater than one second. For instance, the content access presenting module 106* of the computing device 10* of FIG. 3A or 3B providing the access to the content 20 in accordance with the selected level of access by providing (e.g., presenting) the access to the content 20 following lapse of a latency (e.g., time delay) associated with the selected level of access, the lapse of latency being lapse of greater than one second from, for example, the earliest point in time in which the content 20 can be made accessible. The earliest point in time that content 20 can be made accessible may be as a result of, for example, one or more technical limitations, logistical limitations, physical limitations, and/or one or more other limitations.

As further illustrated in FIG. 8B, in some cases, operation 860 may further include an operation 861 for providing the access to the content following lapse of a latency associated with the selected level of access, the lapse of latency being lapse of at least one hour, one day, one week, one month, three months, or one year. For instance, the content access presenting module 106* of the computing device 10* of FIG. 3A or 3B providing (e.g., visually and/or audibly presenting) the access to the content 20 following lapse of a latency associated with the selected level of access, the lapse of latency being lapse of at least one hour, one day, one week, one month, three months, or one year.

In the same or alternative implementations, the content access providing operation 506 may additionally or alternatively include an operation 862 for providing access to the content by providing access to content related to news. For instance, the content access presenting module 106* of the computing device 10* of FIG. 3A or 3B providing access to the content 20 by providing (e.g., presenting) access to content related to news (e.g., sports news, financial news, and so forth).

As further illustrated in FIG. 8B, operation 862 may include one or more additional operations in various implementations including, in some cases, an operation 863 for providing access to the content related to news by providing access to content related to business and/or financial news. For instance, the content access presenting module 106* of the computing device 10* of FIG. 3A or 3B providing access to the content 20 related to news by providing (e.g., presenting) access to content related to business and/or financial news (e.g., stock market or commodity prices).

In some cases, operation 863 may further include an operation 864 for providing access to the content related to business and/or financial news by providing access to content related to market news. For instance, the content access presenting module 106* of the computing device 10* of FIG. 3A or 3B providing access to the content 20 related to business and/or financial news by providing (e.g., presenting) access to content related to market news (e.g., stock prices or commodity prices).

In some implementations, operation 862 may include an operation 865 for providing access to the content related to news by providing access to content related to news of one or more private or public entities. For instance, the content access presenting module 106* of the computing device 10* of FIG. 3A or 3B providing access to the content 20 related to news by providing (e.g., presenting) access to content 20 related to news of one or more private or public entities (e.g., Federal Reserve, Congress, and so forth).

In the same or alternative implementations, operation 862 may additionally or alternatively include an operation 866 for providing access to the content related to news by providing access to content related to news of one or more celebrities. For instance, the content access presenting module 106* of the computing device 10* of FIG. 3A or 3B providing access to the content 20 related to news by providing (e.g., presenting) access to content 20 related to news of one or more celebrities (e.g., human interest stories).

In the same or alternative implementations, operation 862 may additionally or alternatively include an operation 867 for providing access to the content related to news by providing access to content related to one or more of natural disaster news, agricultural news, or general interest news. For instance, the content access presenting module 106* of the computing device 10* of FIG. 3A or 3B providing access to the content 20 related to news by providing (e.g., presenting) access to content 20 related to one or more of natural disaster news, agricultural news, or general interest news.

Turning now to FIG. 8C, in various implementations, the content access providing operation 506 may additionally or alternatively include an operation 868 for providing the access to the content by providing access to consumable media. For instance, the content access presenting module 106* of the computing device 10* of FIG. 3A or 3B providing the access to the content 20 by providing (e.g., presenting) access to consumable media (e.g., feature movies, documentaries, novels, digital music, and so forth).

As further illustrated in FIG. 8C, operation 868 may include one or more additional operations in various alternative implementations. For example, in some implementations, operation 868 may further include an operation 869 for providing the access to the consumable media by providing access to video media. For instance, the content access presenting module 106* of the computing device 10* of FIG. 3A or 3B providing the access to the consumable media by providing (e.g., presenting) access to video media (e.g., recording of a sporting event, a news report, and so forth).

In some cases, operation 869 may further include or involve an operation 870 for providing the access to the video media by providing access to at least one of a movie, a television show, or a documentary. For instance, the content access presenting module 106* of the computing device 10* of FIG. 3A or 3B providing the access to the video media by providing (e.g., presenting) access to at least one of a movie, a television show, or a documentary.

In some implementations, operation 868 may further include an operation 871 for providing the access to the consumable media by providing access to audio media. For instance, the content access presenting module 106* of the computing device 10* of FIG. 3A or 3B providing the access to the consumable media by providing (e.g., presenting) access to audio media.

In some cases, operation 871 may further include or involve an operation 872 for providing the access to audio media by providing access to at least one of music or audio recording. For instance, the content access presenting module 106* of the computing device 10* of FIG. 3A or 3B providing the access to audio media by providing (e.g., presenting) access to at least one of music or audio recording (e.g., top ten hits, audio recording of a musical, a soundtrack, recording of a seminar or a speech, and so forth).

In some implementations, operation 868 may further include an operation 873 for providing the access to the consumable media by providing access to textual media. For instance, the content access presenting module 106* of the computing device 10* of FIG. 3A or 3B providing the access to the consumable media by providing (e.g., presenting) access to textual media.

In some cases, operation 873 may further include or involve an operation 874 for providing the access to the textual media by providing access to one or more electronic books including at least one of an electronic novel, an electronic biography, or an electronic reference book. For instance, the content access presenting module 106* of the computing device 10* of FIG. 3A or 3B providing the access to the textual media by providing (e.g., presenting) access to one or more electronic books including at least one of an electronic novel, an electronic biography, or an electronic reference book.

Turning now to FIG. 8D, in various implementations, the content access providing operation 506 may include or involve an operation 875 for providing the access to the content including access to information indicating number of users who have already accessed the content. For instance, the content access presenting module 106* of the computing device 10* of FIG. 3A or 3B providing (e.g., presenting) the access to the content 20 including access to information (see, for example, previous user information 254 in FIG. 2J) indicating number of users who have already accessed the content.

In the same or alternative implementations, the content access providing operation 506 may additionally or alternatively include an operation 876 for providing the access to the content including access to information indicating one or more identities of one or more users who have already accessed the content. For instance, the content access presenting module 106* of the computing device 10* of FIG. 3A or 3B providing (e.g., presenting) the access to the content 20 including access to information (see, for example, previous user information 254 in FIG. 2J) indicating one or more identities of one or more users who have already accessed the content 20.

In the same or alternative implementations, the content access providing operation 506 may additionally or alternatively include an operation 877 for providing the access to the content including access to information indicating how one or more users who have already accessed the content were able to actually access the content. For instance, the content access presenting module 106* of the computing device 10* of FIG. 3A or 3B providing (e.g., presenting) the access to the content 20 including access to information (see, for example, previous user information 254 in FIG. 2J, which indicates when other users had previously viewed the content 20) indicating how one or more users who have already accessed the content were able to actually access the content 20. For example, providing access to information that indicates the communication channels used by other users to access the content 20.

In the same or alternative implementations, the content access providing operation 506 may additionally or alternatively include an operation 878 for providing the access to the content by providing access to content obtained from multiple sources in accordance with the selected level of access. For instance, the content access presenting module 106* of the computing device 10* of FIG. 3A or 3B providing the access to the content 20 by providing (e.g., presenting) access to content 20 obtained from multiple sources (e.g., multiple social networking sources) in accordance with the selected level of access.

In the same or alternative implementations, the content access providing operation 506 may additionally or alternatively include an operation 879 for providing the access to the content including providing access to contextual data related to the content. For instance, the content access presenting module 106* including the contextual data presenting module 422 (see FIG. 4C) of the computing device 10* of FIG. 3A or 3B providing the access to the content 20 when the contextual data presenting module 422 provides (e.g., presents) access to contextual data (e.g., movie trailer, celebrity background information, historical market information, historical interest rates, etc.) related to the content 20.

In some implementations, operation 879 may further include or involve an operation 880 for providing the access to the contextual data related to the content by providing access to historical information related to the content. For instance the contextual data presenting module 422 including the historical data presenting module 424 (see FIG. 4C) of the computing device 10* of FIG. 3A or 3B providing the access to the contextual data related to the content 20 by providing (e.g., presenting) access to historical information (e.g., historical market data, historical crop data, historical criminal record, and so forth) related to the content 20.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructionsper_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinct ion left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1-161. (canceled)

162. A system, comprising:
a selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees;
a selection obtaining module configured to obtain from a content consumer a selection of the level of access for accessing the content from the plurality of graduated levels of access to the content; and
a content access presenting module configured to present access to the content following lapse of a latency associated with the selected level of access for accessing the content.

163. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module including a slider feature presenting module configured to present the selection GUI for selecting the level of access for accessing the content when the slider feature presenting module presents a slider feature for selecting the level of access for accessing the content from the plurality of graduated levels of access for accessing the content.

164. The system of claim 163, wherein said selection GUI presenting module including a slider feature presenting module configured to present the selection GUI for selecting the level of access for accessing the content when the slider feature presenting module presents a slider feature for selecting the level of access for accessing the content from the plurality of graduated levels of access for accessing the content comprises:
a slider feature presenting module configured to present a slider feature that includes a slider icon that is designed to be moveable, in response to user input, along length of an elongated element having a first end and a second end at opposite ends of the length of the elongated element, the slider icon being designed to be moved along the length of the elongated element from the first end to the second end to select the level of access for accessing the content.

165. The system of claim 164, wherein said slider feature presenting module configured to present a slider feature that includes a slider icon that is designed to be moveable, in response to user input, along length of an elongated element having a first end and a second end at opposite ends of the length of the elongated element, the slider icon being designed to be moved along the length of the elongated element from the first end to the second end to select the level of access for accessing the content comprises:
a slider feature presenting module configured to present a slider feature that includes the slider icon that is designed to be moveable, in response to the user input, along the length of the elongated element having multiple points along the length of the elongated element including the first end and the second end, the multiple points along the length of the elongated element from the first end to the second end being associated with graduated levels of access for accessing the content with varying amounts of latencies for accessing the content and varying amounts of corresponding fees, the first end corresponding to highest level of access that is available through the slider feature for accessing the content with lowest amount of latency and highest fee that are available through the slider feature and the second end corresponding to lowest access available through the slider feature for accessing the content with highest amount of latency and lowest fee that are available through the selecting feature, and each point along the elongated element from the second end to the first end corresponding to incrementally increasing levels of access to the content with decreasing amounts of latencies and increasing amounts of corresponding fees.

166. The system of claim 164, wherein said slider feature presenting module configured to present a slider feature that includes a slider icon that is designed to be moveable, in response to user input, along length of an elongated element having a first end and a second end at opposite ends of the length of the elongated element, the slider icon being designed to be moved along the length of the elongated element from the first end to the second end to select the level of access for accessing the content comprises:
a slider feature presenting module configured to present a slider feature that includes the slider icon that is designed to be moveable, in response to the user input, along the length of the elongated element having at least three points along the length of the elongated element including the first end and the second end, each of the at least three points along the length of the elongated element from the first end to the second end being associated with a different level of access for accessing the content with a different amount of latency for accessing the content and different amount of corresponding fee.

167. (canceled)

168. (canceled)

169. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
an icon presenting module configured to present a plurality of icons for selecting the level of access for accessing the content from the plurality of graduated levels of access for accessing the content, each icon to be displayed being associated with a different level of access for accessing the content with a different amount of latency for accessing the content and different amount of corresponding fee.

170. (canceled)

171. (canceled)

172. (canceled)

173. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present a selection GUI for selecting a level of access for accessing the content from at least three graduated levels of access for accessing the content, the at least three graduated levels of access for accessing the content corresponding to three different amounts of latencies and three different amounts of corresponding fees.

174. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present a selection GUI for selecting a level of access for accessing the content from at least ten graduated levels of access for accessing the content, the at least ten graduated levels of access for accessing the content corresponding to ten different amounts of latencies and ten different amounts of corresponding fees.

175. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present the selection GUI for selecting the level of access for accessing content from the plurality of graduated levels of access for accessing the content, the plurality of graduated levels of access for accessing the content being for accessing the content with the varying amounts of latencies and for the varying amounts of corresponding fees, the plurality of graduated levels of access further for accessing varying amounts of contextual data.

176. (canceled)

177. The system of claim 175, wherein said selection GUI presenting module configured to present the selection GUI for selecting the level of access for accessing content from the plurality of graduated levels of access for accessing the content, the plurality of graduated levels of access for accessing the content being for accessing the content with the varying amounts of latencies and for the varying amounts of corresponding fees, the plurality of graduated levels of access further for accessing varying amounts of contextual data comprises:
a selection GUI presenting module configured to present a selection GUI for selecting a level of access for accessing content from a plurality of graduated levels of access for accessing the content including for accessing varying amounts of contextual data provided from varying amounts of contextual sources, wherein the greatest level of access available through the selection GUI providing contextual data from greatest number of contextual sources and wherein the lowest level of access available through the selection GUI providing contextual data from lowest number of contextual sources.

178-196. (canceled)

197. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present a selection GUI for selecting the level of access for accessing the content from a plurality of explicitly indicated graduated levels of access for accessing the content.

198. The system of claim 197, wherein said selection GUI presenting module configured to present a selection GUI for selecting the level of access for accessing the content from a plurality of explicitly indicated graduated levels of access for accessing the content comprises:
a selection GUI presenting module configured to present a selection GUI for selecting the level of access, the selection GUI indicating graduated amounts of latencies associated with the graduated levels of access for accessing the content.

199. The system of claim 197, wherein said selection GUI presenting module configured to present a selection GUI for selecting the level of access for accessing the content from a plurality of explicitly indicated graduated levels of access for accessing the content comprises:
a selection GUI presenting module configured to present a selection GUI for selecting the level of access, the selection GUI indicating graduated amounts of fees associated with the graduated levels of access for accessing the content.

200. (canceled)

201. (canceled)

202. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present a selection GUI for selecting the level of access for accessing the content, the selection GUI further providing an option to be provided with information indicating who, when, and/or how many users have already previously accessed the content.

203. The system of claim 162, wherein said selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees comprises:
a selection GUI presenting module configured to present a selection GUI for selecting the level of access for accessing the content, the selection GUI further providing information indicating who, when, and/or how many users have already previously accessed the content.

204-207. (canceled)

208. The system of claim 162, wherein said selection obtaining module configured to obtain from a content consumer a selection of the level of access for accessing the content from the plurality of graduated levels of access to the content comprises:
a selection obtaining module configured to obtain the selection of the level of access for accessing the content, the obtained selection including an election to receive information indicating who, when, and/or how many users have already previously accessed the content.

209. The system of claim 162, wherein said selection obtaining module configured to obtain from a content consumer a selection of the level of access for accessing the content from the plurality of graduated levels of access to the content comprises:
a selection obtaining module configured to obtain the selection of the level of access for accessing the content, the obtained selection including an election to acquire the content through one or more particular communication links.

210-216. (canceled)

217. The system of claim 162, wherein said content access presenting module configured to present access to the content following lapse of a latency associated with the selected level of access for accessing the content comprises:
a content access presenting module configured to retrieve the content only after lapse of a time increment or interval associated with the latency associated with the selected level of access for accessing the content.

218. The system of claim 162, wherein said content access presenting module configured to present access to the content following lapse of a latency associated with the selected level of access for accessing the content comprises:
a content access presenting module configured to present the access to the content following lapse of a time interval associated with the latency, the lapse of the time interval being lapse of a time span immediately following earliest point in time in which the content is publicly available.

219. The system of claim 162, wherein said content access presenting module configured to present access to the content following lapse of a latency associated with the selected level of access for accessing the content comprises:
a content access presenting module configured to present the access to the content following lapse of a time interval associated with the latency, the lapse of the time interval being lapse of a time span immediately following earliest point in time in which the content comes into existence.

220. The system of claim 162, wherein said content access presenting module configured to present access to the content following lapse of a latency associated with the selected level of access for accessing the content comprises:
a content access presenting module configured to present the access to the content following lapse of a latency associated with the selected level of access, the lapse of latency being lapse of less than one second.

221. (canceled)

222. (canceled)

223. The system of claim 162, wherein said content access presenting module configured to present access to the content following lapse of a latency associated with the selected level of access for accessing the content comprises:
a content access presenting module configured to present access to content related to news.

224. The system of claim 223, wherein said content access presenting module configured to present access to content related to news comprises:
a content access presenting module configured to present access to content related to business and/or financial news.

225. The system of claim 224, wherein said content access presenting module configured to present access to content related to business and/or financial news comprises:
a content access presenting module configured to present access to content related to market news.

226. The system of claim 223, wherein said content access presenting module configured to present access to content related to news comprises:
a content access presenting module configured to present access to content related to news of one or more private or public entities.

227. The system of claim 223, wherein said content access presenting module configured to present access to content related to news comprises:
a content access presenting module configured to present access to content related to news of one or more human interest stories.

228. The system of claim 223, wherein said content access presenting module configured to present access to content related to news comprises:
a content access presenting module configured to present access to content related to one or more of natural disaster news, agricultural news, or general interest news.

229. The system of claim 162, wherein said content access presenting module configured to present access to the content following lapse of a latency associated with the selected level of access for accessing the content comprises:
a content access presenting module configured to present access to consumable media.

230. The system of claim 229, wherein said content access presenting module configured to present access to consumable media comprises:
a content access presenting module configured to present access to video media.

231. (canceled)

232. The system of claim 229, wherein said content access presenting module configured to present access to consumable media comprises:
a content access presenting module configured to present access to audio media.

233. (canceled)

234. The system of claim 229, wherein said content access presenting module configured to present access to consumable media comprises:
a content access presenting module configured to present access to textual media.

235. (canceled)

236. The system of claim 162, wherein said content access presenting module configured to present access to the content following lapse of a latency associated with the selected level of access for accessing the content comprises:
a content access presenting module configured to present access to information indicating number of users who have already accessed the content.

237. The system of claim 162, wherein said content access presenting module configured to present access to the content following lapse of a latency associated with the selected level of access for accessing the content comprises:
a content access presenting module configured to present access to information indicating one or more identities of one or more users who have already accessed the content.

238. The system of claim 162, wherein said content access presenting module configured to present access to the content following lapse of a latency associated with the selected level of access for accessing the content comprises:
a content access presenting module configured to present access to information indicating how one or more users who have already accessed the content were able to actually access the content.

239. The system of claim 162, wherein said content access presenting module configured to present access to the content following lapse of a latency associated with the selected level of access for accessing the content comprises:
a content access presenting module configured to present access to content obtained from multiple sources in accordance with the selected level of access.

240. The system of claim 162, wherein said content access presenting module configured to present access to the content following lapse of a latency associated with the selected level of access for accessing the content comprises:
a contextual data presenting module configured to present access to contextual data related to the content.

241. The system of claim 240, wherein said contextual data presenting module configured to present access to contextual data related to the content comprises:
a historical data presenting module configured to present access to historical information related to the content.

242. An article of manufacture, comprising:
one or more instructions for presenting a selection graphical user interface (GUI) for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees;
one or more instructions for obtaining from a content consumer a selection of the level of access for accessing the content from the plurality of graduated levels of access to the content; and
one or more instructions for presenting access to the content following lapse of a latency associated with the selected level of access for accessing the content.

243. A system, comprising:
a selection graphical user interface (GUI) presenting module configured to present a selection GUI for selecting a level of access for accessing content from a plurality of graduated levels of access for accessing the content, the plurality of graduated levels of access for accessing the content being for accessing the content with varying amounts of latency, the varying amounts of latency associated with the plurality of graduated levels of access for accessing the content being further associated with varying amounts of corresponding fees;
a selection obtaining module configured to obtain from a content consumer a selection of the level of access for accessing the content from the plurality of graduated levels of access to the content;
a content access presenting module configured to present access to the content following lapse of a latency associated with the selected level of access for accessing the content; and
a user interface for presenting the content.
